(19) United States
(12) Patent Application Publication
(10) Pub. No.: US 2025/0023649 A1
(43) Pub. Date: Jan. 16, 2025

(54) METHOD AND DEVICE IN NODES USED FOR WIRELESS COMMUNICATION

(71) Applicants: Lu WU, Shanghai (CN); Shulin SONG, Shanghai (CN); Xiaobo ZHANG, Shanghai (CN)

(72) Inventors: Lu WU, Shanghai (CN); Shulin SONG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/766,678

(22) Filed: Jul. 9, 2024

(30) Foreign Application Priority Data
Jul. 10, 2023 (CN) 202310841476.7

(51) Int. Cl. H04B 17/309; H04W 72/0446

(52) U.S. Cl. CPC H04B 17/309; H04W 72/0446

(57) ABSTRACT

The present application provides a method and device in a node for wireless communications. A first node receives a reference information block and a first information block; wherein the reference information block is used to determine a first RS resource set used for a radio link quality measurement, and the first RS resource set comprises at least one RS resource; the first information block is used to determine a reference time-domain resource set; a first RS resource is an RS resource in the first RS resource set, and a transmission occasion of the first RS resource used for the radio link quality measurement depends on the reference time-domain resource set.

### CROSS REFERENCE TO RELATED APPLICATIONS

The present application claims the priority benefit of Chinese Patent Application No. 202310841476.7, filed on Jul. 10, 2023, the full disclosure of which is incorporated herein by reference.

### BACKGROUND

### Technical Field

The present application relates to transmission methods and devices in wireless communication systems, and in particular to a measurement scheme and devices in a wireless communication system.

### Related Art

In the existing NR (New Radio) system, spectrum resources are statically divided into FDD (Frequency Division Duplexing) spectrum and TDD (Time Division Duplexing) spectrum. For the TDD spectrum, both the base station and User Equipment (UE) operate in half-duplex mode. This half-duplex mode avoids self-interference and can mitigate the impact of Cross Link interference, but also brings about a decrease in resource utilization and an increase in latency. For these problems, supporting flexible duplex mode on the TDD spectrum or FDD spectrum becomes a possible solution. A research work on duplex technology was agreed at 3GPP RAN (Radio Access Network) 1 #103e meeting, in which SubBand non-overlapping Full Duplex (SBFD) was proposed, i.e., the base station is supported to simultaneously transmit and receive on two subbands at the same time. Communications in this mode is subject to severe interference, both self-interference and cross-link interference.

### SUMMARY

Inventors have found through researches that how to determine a transmission occasion of RS (Reference Signal) resources used for radio link quality measurement is a key issue.

To address the above problem, the present application provides a solution. It should be noted that in the description of the application, flexible duplex mode is only used as a typical application scenario or example; the present application can also be applied to other scenarios facing similar problems (including but not limited to SBFD, other flexible duplex or full duplex modes, variable link direction modes, traditional duplex modes, half duplex modes, energy-saving scenarios, non-energy-saving scenarios, capacity enhancement systems, close range communication systems, unlicensed frequency-domain communications, IoT (Internet of Things), URLLC (Ultra Reliable Low Latency Communication) networks, Internet of Vehicles (IoV), etc.), where similar technical effects can be achieved. Additionally, adopting a unified design approach for different scenarios can also help reduce hardware complexity and cost. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:

receiving a reference information block and a first information block:

herein, the reference information block is used to determine a first RS resource set used for a radio link quality measurement, and the first RS resource set comprises at least one RS resource: the first information block is used to determine a reference time-domain resource set: a first RS resource is an RS resource in the first RS resource set, and a transmission occasion of the first RS resource used for the radio link quality measurement depends on the reference time-domain resource set.

In one embodiment, a problem to be solved in the present application comprises: how to determine a transmission occasion of RS resources used for a radio link quality measurement.

In one embodiment, advantages of adopting the above method comprise: radio link quality evaluation is flexibly adjusted by determining an appropriate transmission occasion of RS resources used for a radio link quality measurement.

In one embodiment, advantages of adopting the above method comprise: beam failure monitoring is flexibly adjusted by determining an appropriate transmission occasion of RS resources used for a radio link quality measurement.

In one embodiment, advantages of adopting the above method comprise: candidate beam monitoring is flexibly adjusted by determining an appropriate transmission occasion of RS resources used for a radio link quality measurement.

In one embodiment, advantages of adopting the above method comprise: radio link monitoring is flexibly adjusted by determining an appropriate transmission occasion of RS resources used for a radio link quality measurement.

In one embodiment, the above methods support SBFD technology, improve uplink coverage, and increase uplink transmission capacity.

In one embodiment, advantages of adopting the above method comprise: being suitable for different application scenarios/environment/modes, thus improving the flexibility of the system.

According to one aspect of the present application, it is characterized in that any transmission occasion of the first RS resource used for the radio link quality measurement is orthogonal to the reference time-domain resource set.

In one embodiment, characteristics of the above method include: measuring radio link quality only according to a transmission occasion of an RS resource that is orthogonal to the reference time-domain resource set.

According to one aspect of the present application, it is characterized in that only when the first RS resource is a CSI-RS resource, a transmission occasion of the first RS resource used for the radio link quality measurement depends on the reference time-domain resource set.

In one embodiment, advantages of adopting the above method comprise: for CSI-RS resources, selecting an appropriate transmission occasion used for a radio link quality measurement improves the flexibility and accuracy of the radio link quality measurement.

According to one aspect of the present application, it is characterized in that in an evaluation period, the first node evaluates radio link quality based on a measurement on at least one transmission occasion of the first RS resource: in an evaluation period, which transmission occasion(s) of the first RS resource is (are) measured for evaluating the radio link quality depends on the reference time-domain resource set.

In one embodiment, advantages of adopting the above method comprise: in an evaluation period, an appropriate transmission occasion of RS resources is selected, which improves the flexibility and accuracy of the radio link quality measurement.

According to one aspect of the present application, it is characterized in that in an evaluation period, a number or proportion of transmission occasion(s) of the first RS resource orthogonal to the reference time-domain resource set is not less than a first value, or a number or proportion of transmission occasion(s) of the first RS resource overlapping with the reference time-domain resource set is not greater than a second value.

In one embodiment, advantages of adopting the above method comprise: ensuring sufficient number of measurements in an evaluation period through the first value and the second value.

In one embodiment, advantages of adopting the above method comprise: having good backward compatibility and simplifying the design of radio link quality measurement.

According to one aspect of the present application, it is characterized in that the first RS resource set is used for candidate beam monitoring, and in an evaluation period, when a number or proportion of transmission occasion(s) of the first RS resource overlapping with the reference time-domain resource set is greater than the second value, no new candidate beam is found in the evaluation period:

or, the first RS resource set is used for radio link monitoring, and in an evaluation period, when a number or proportion of transmission occasion(s) of the first RS resource overlapping with the reference time-domain resource set is greater than the second value, the first node does not transmit an in-sync indication to its higher layer.

In one embodiment, advantages of adopting the above method comprise: ensuring sufficient number of measurements before selecting a new candidate beam.

In one embodiment, advantages of adopting the above method comprise: pre-judging whether a new candidate beam is found, thus simplifying the procedure of candidate beam monitoring.

In one embodiment, advantages of adopting the above method comprise: ensuring sufficient number of measurements before transmitting an in-sync indication to higher layer.

In one embodiment, advantages of adopting the above method comprise: pre-judging whether the UE is in-sync, so as to simplify radio link monitoring procedure.

According to one aspect of the present application, it is characterized in that a length of an evaluation period depends on a number or proportion of transmission occasion(s) of the first RS resource overlapping with the reference time-domain resource set in the evaluation period: or, a length of an evaluation period depends on a number or proportion of transmission occasion(s) of the first RS resource overlapping with the reference time-domain resource set in a most recent evaluation period prior to the evaluation period.

In one embodiment, advantages of adopting the above method comprise: flexibly adjusting a length of an evaluation period, thus improving the accuracy of radio link quality measurement.

In one embodiment, advantages of adopting the above method comprise: being applicable to different application scenarios/environment/modes, thus improving the flexibility of the system.

The present application provides a method in a second node for wireless communications, comprising:
transmitting a reference information block and a first information block;
herein, the reference information block is used to determine a first RS resource set used for a radio link quality measurement, and the first RS resource set comprises at least one RS resource: the first information block is used to determine a reference time-domain resource set: a first RS resource is an RS resource in the first RS resource set, and a transmission occasion of the first RS resource used for the radio link quality measurement depends on the reference time-domain resource set.

According to one aspect of the present application, it is characterized in that any transmission occasion of the first RS resource used for the radio link quality measurement is orthogonal to the reference time-domain resource set.

According to one aspect of the present application, it is characterized in that only when the first RS resource is a CSI-RS resource, a transmission occasion of the first RS resource used for the radio link quality measurement depends on the reference time-domain resource set.

According to one aspect of the present application, it is characterized in that in an evaluation period, a receiver of the first RS resource set evaluates radio link quality based on a measurement on at least one transmission occasion of the first RS resource: in an evaluation period, which transmission occasion(s) of the first RS resource is (are) measured for evaluating the radio link quality depends on the reference time-domain resource set.

According to one aspect of the present application, it is characterized in that in an evaluation period, a number or proportion of transmission occasion(s) of the first RS resource orthogonal to the reference time-domain resource set is not less than a first value, or a number or proportion of transmission occasion(s) of the first RS resource overlapping with the reference time-domain resource set is not greater than a second value.

According to one aspect of the present application, it is characterized in that the first RS resource set is used for candidate beam monitoring, and in an evaluation period, when a number or proportion of transmission occasion(s) of the first RS resource overlapping with the reference time-domain resource set is greater than the second value, no new candidate beam is found in the evaluation period:

or, the first RS resource set is used for radio link monitoring, and in an evaluation period, when a number or proportion of transmission occasion(s) of the first RS resource overlapping with the reference time-domain resource set is greater than the second value, a receiver of the first RS resource set does not transmit an in-sync indication to its higher layer.

According to one aspect of the present application, it is characterized in that a length of an evaluation period depends on a number or proportion of transmission occasion(s) of the first RS resource overlapping with the reference time-domain resource set in the evaluation period: or, a length of an evaluation period depends on a number or proportion of transmission occasion(s) of the first RS resource overlapping with the reference time-domain resource set in a most recent evaluation period prior to the evaluation period.

The present application provides a first node for wireless communications, comprising:
a first receiver, receiving a reference information block and a first information block;
herein, the reference information block is used to determine a first RS resource set used for a radio link quality measurement, and the first RS resource set comprises at least one RS resource: the first information block is used to determine a reference time-domain resource set: a first RS resource is an RS resource in the first RS resource set, and a transmission occasion of the first RS resource used for the radio link quality measurement depends on the reference time-domain resource set.

The present application provides a second node for wireless communications, comprising:
a second transmitter, transmitting a reference information block and a first information block;
herein, the reference information block is used to determine a first RS resource set used for a radio link quality measurement, and the first RS resource set comprises at least one RS resource: the first information block is used to determine a reference time-domain resource set: a first RS resource is an RS resource in the first RS resource set, and a transmission occasion of the first RS resource used for the radio link quality measurement depends on the reference time-domain resource set.

In one embodiment, the present application has the following advantages over conventional schemes:
flexibly determining a transmission occasion of RS resources used for radio link quality measurement;
flexibly adjusting radio link quality measurement;
flexibly adjusting beam failure monitoring, candidate beam monitoring and radio link monitoring;
being applicable to different application scenarios/environment/modes, thus improving the flexibility of the system;
increasing the uplink transmission capacity;
improving the reliability of communication transmission;
guaranteeing the service quality of the communication system.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a reference information block and a first information block according to one embodiment of the present application;

FIG. 2 illustrates a schematic diagram of a network architecture according to one embodiment of the present application:

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application:

FIG. 5 illustrates a flowchart of wireless transmission according to one embodiment of the present application;

FIGS. 6A-6C respectively illustrate a schematic diagram of a first RS resource set according to one embodiment of the present application:

FIG. 7 illustrates a schematic diagram of relations between a transmission occasion of a first RS resource and a reference time-domain resource set according to one embodiment of the present application;

FIG. 8 illustrates a schematic diagram of a first RS resource according to one embodiment of the present application;

FIG. 9 illustrates a schematic diagram of an evaluation period and a transmission occasion of a first RS resource according to one embodiment of the present application:

FIG. 10 illustrates a schematic diagram of relations among a first RS resource, radio link quality and a first reference threshold according to one embodiment of the present application:

FIG. 11 illustrates a schematic diagram of relations among a first RS resource, radio link quality and a second reference threshold according to one embodiment of the present application;

FIG. 12 illustrates a schematic diagram of relations among a first RS resource, radio link quality and a third reference threshold according to one embodiment of the present application;

FIG. 13 illustrates a schematic diagram of relations among a first RS resource, radio link quality and a fourth reference threshold according to one embodiment of the present application:

FIGS. 14A-14B respectively illustrate a schematic diagram of a first value and a second value according to one embodiment of the present application:

FIGS. 15A-15B respectively illustrate a schematic diagram of a number or proportion of transmission occasion(s) of a first RS resource according to one embodiment of the present application:

FIGS. 16A-16B respectively illustrate a schematic diagram of a length of an evaluation period according to one embodiment of the present application:

FIG. 17 illustrates a structure block diagram of a processor in a first node according to one embodiment of the present application:

FIG. 18 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

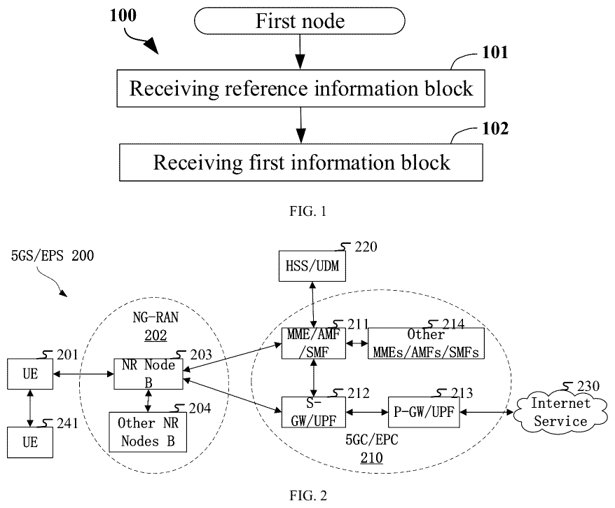

Embodiment 1 illustrates a flowchart of a reference information block and a first information block according to one embodiment of the present application, as shown in FIG. 1. In 100 illustrated by FIG. 1, each box represents a step.

In Embodiment 1, the first node in the present application receives a reference information block in step 101; receives a first information block in step 102: herein, the reference information block is used to determine a first RS resource set used for a radio link quality measurement, and the first RS resource set comprises at least one RS resource; the first information block is used to determine a reference time-domain resource set: a first RS resource is an RS resource in the first RS resource set, and a transmission occasion of the first RS resource used for the radio link quality measurement depends on the reference time-domain resource set.

In one embodiment, the first information block is carried by a higher-layer signaling.

In one embodiment, the first information block is carried by an RRC (Radio Resource Control) signaling.

In one embodiment, the first information block comprises all or partial fields in an RRC IE (Information Element).

In one embodiment, the first information block comprises all or partial fields in each RRC IE in multiple RRC IEs.

In one embodiment, the first information block comprises all or partial fields in a TDD-UL-DL-ConfigCommon IE.

In one embodiment, the first information block comprises all or partial fields in a TDD-UL-DL-ConfigDedicated IE.

In one embodiment, the first information block comprises all or partial fields in a ServingCellConfig IE.

In one embodiment, the first information block comprises all or partial fields in a ServingCellConfigCommonSIB IE.

In one embodiment, the first information block comprises information in all or partial fields in a ServingCellConfigCommon IE.

In one embodiment, the first information block is carried by at least one RRC IE.

In one embodiment, a name of an IE carrying the first information block comprises TDD-UL-DL-Config.

In one embodiment, a name of an IE carrying the first information block comprises ServingCellConfig.

In one embodiment, the first information block is carried by a Medium Access Control layer Control Element (MAC CE).

In one embodiment, the first information block comprises a MAC CE.

In one embodiment, the first information block is transmitted on a downlink physical layer data channel (i.e., a downlink channel capable of bearing physical layer data).

In one embodiment, the first information block is transmitted on a PDSCH.

In one embodiment, the first information block is carried by DCI (Downlink control information).

In one embodiment, the first information block comprises DCI.

In one embodiment, the first information block comprises one or multiple fields in a DCI.

In one embodiment, the first information block is carried by DCI format 2_0.

In one embodiment, the first information block comprises DCI format 2_0.

In one embodiment, the first information block is carried by an RRC signaling and a MAC CE together.

In one embodiment, the first information block is carried by a higher layer signaling and DCI together.

In one embodiment, the first information block is used by the first node to determine the reference time-domain resource set.

In one embodiment, the first information block indicates the reference time-domain resource set.

In one embodiment, the first information block is used to indicate the reference time-domain resource set.

In one embodiment, the first information block explicitly indicates the reference time-domain resource set.

In one embodiment, the first information block implicitly indicates the reference time-domain resource set.

In one embodiment, the first information block indicates period and time offset of the reference time-domain resource set.

In one embodiment, the first information block indicates time-domain resources comprised in the reference time-domain resource set within one cycle.

In one embodiment, the first information block indicates symbol(s) comprised in the reference time-domain resource set within one cycle.

In one embodiment, the first information block indicates slot(s) comprised in the reference time-domain resource set within one cycle.

In one embodiment, the reference time-domain resource set comprises a positive integer number of symbol(s).

In one embodiment, the reference time-domain resource set comprises one or multiple symbols.

In one embodiment, the reference time-domain resource set comprises one symbol.

In one embodiment, the reference time-domain resource set comprises multiple symbols.

In one embodiment, the reference time-domain resource set comprises at least one slot.

In one embodiment, the reference time-domain resource set comprises at least one subframe.

In one embodiment, the symbol is a single carrier symbol.

In one embodiment, the symbol is a multicarrier symbol.

In one embodiment, the multicarrier symbol is an Orthogonal Frequency Division Multiplexing (OFDM) symbol.

In one embodiment, the symbol is obtained after an output of transform precoding through OFDM symbol generation.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the multi-carrier symbol is a Filter Bank Multi-Carrier (FBMC) symbol.

In one embodiment, the multicarrier symbol comprises a Cyclic Prefix (CP).

In one embodiment, the reference time-domain resource set comprises symbols used for both uplink and downlink transmission simultaneously.

In one embodiment, any symbol in the reference time-domain resource set can be used for both uplink transmission and downlink transmission simultaneously.

In one embodiment, any symbol in the reference time-domain resource set is used for both uplink transmission and downlink transmission simultaneously.

In one embodiment, at least one symbol in the reference time-domain resource set is used for both uplink transmission and downlink transmission simultaneously.

In one embodiment, at least one symbol in the reference time-domain resource set is configured for both uplink and downlink.

In one embodiment, each symbol in the reference time-domain resource set is configured for both uplink and downlink.

In one embodiment, at least one symbol in the reference time-domain resource set is used for both uplink and downlink.

In one embodiment, each symbol in the reference time-domain resource set is used for both uplink and downlink.

In one embodiment, at least one symbol in the reference time-domain resource set is configured for uplink in part of RBs and used for downlink in another part of RBs.

In one embodiment, at least one symbol in the reference time-domain resource set is used for uplink in part of RBs and used for downlink in another part of RBs.

In one embodiment, each symbol in the reference time-domain resource set is configured for uplink in part of RBs and for downlink in another part of RBs.

In one embodiment, each symbol in the reference time-domain resource set is used for uplink in part of RBs and used for downlink in another part of RBs.

In one embodiment, at least one symbol in the reference time-domain resource set is configured for uplink in part of RBs in a first BWP and for downlink in another part of RBs in the first BWP.

In one embodiment, at least one symbol in the reference time-domain resource set is used for uplink in part of RBs in a first BWP and used for downlink in another part of RBs in the first BWP.

In one embodiment, each symbol in the reference time-domain resource set is configured for uplink in part of RBs in a first BWP and for downlink in another part of RBs in the first BWP.

In one embodiment, each symbol in the reference time-domain resource set is used for uplink in part of RBs in a first BWP and used for downlink in another part of RBs in the first BWP.

In one embodiment, the reference time-domain resource set does not comprise a symbol used for a transmission of a first-type downlink signal, the first-type downlink signal comprises one or more of an SS (Synchronization Signal)/PBCH (Physical Broadcast Channel) Block, a CORESET (Control Resource Set) indexed 0 or an SIB (System Information Block).

In one embodiment, the reference time-domain resource set comprises one or multiple symbols, at least one symbol in the reference time-domain resource set is configured as a DL symbol by higher-layer parameters, and one or more subcarriers in one or multiple DL symbols in the reference time-domain resource set are used for uplink transmission.

In one embodiment, one or more RBs in one or multiple DL symbols of the reference time-domain resource set are used for uplink transmission.

In one embodiment, each symbol in the reference time-domain resource set is configured as a DL symbol by higher-layer parameters.

In one embodiment, each symbol in the reference time-domain resource set is configured as a DL symbol or Flexible symbol by higher-layer parameters.

In one embodiment, at least one symbol in the reference time-domain resource set is configured as a DL symbol by higher-layer parameters, and at least one symbol in the reference time-domain resource set is configured as a Flexible symbol by higher-layer parameters.

In one embodiment, the reference time-domain resource set is allocated to a serving cell.

In one embodiment, the reference time-domain resource set is configured to a serving cell where the first RS resource set is located.

In one embodiment, the reference time-domain resource set is configured to at least one BWP (BandWidth Part).

In one embodiment, the reference time-domain resource set is allocated to a BWP.

In one embodiment, the reference time-domain resource set is allocated to a DL BWP.

In one embodiment, the reference time-domain resource set is configured to a DL BWP where the first RS resource set is located.

In one embodiment, the higher-layer parameters are carried by an RRC (Radio Resource Control) signaling.

In one embodiment, the higher-layer parameters comprise all or partial fields in an RRC IE (Information Element).

In one embodiment, the higher-layer parameters comprise all or partial fields in each RRC IE in multiple RRC IEs.

In one embodiment, the higher-layer parameters comprise all or partial fields in a TDD-UL-DL-ConfigCommon IE.

In one embodiment, the higher-layer parameters comprise all or partial fields in a TDD-UL-DL-ConfigDedicated IE.

In one embodiment, the higher-layer parameters comprise all or partial fields in a ServingCellConfig IE.

In one embodiment, the higher-layer parameters comprise all or partial fields in a Serving CellConfigCommonSIB IE.

In one embodiment, the higher-layer parameters comprise information in all or partial fields in a ServingCellConfigCommon IE.

In one embodiment, the higher-layer parameters are carried by at least one RRC IE.

In one embodiment, a name of an IE carrying the higher-layer parameter comprises TDD-UL-DL-Config.

In one embodiment, a name of an IE carrying the higher-layer parameter comprises ServingCellConfig.

In one embodiment, the uplink transmission in one or multiple DL symbols of the reference time-domain resource set comprises at least one of PUSCH (Physical Uplink Shared Channel), PUCCH (Physical Uplink Control Channel), PRACH (Physical Random Access Channel), or SRS (Sounding Reference Signal).

In one embodiment, the uplink transmission in one or multiple DL symbols of the reference time-domain resource set comprises a PUSCH.

In one embodiment, the uplink transmission in one or multiple DL symbols of the reference time-domain resource set comprises a PUCCH.

In one embodiment, the uplink transmission in one or multiple DL symbols of the reference time-domain resource set comprises a PRACH.

In one embodiment, the uplink transmission in one or multiple DL symbols of the reference time-domain resource set comprises an SRS.

In one embodiment, the reference time-domain resource set comprises symbols used for full duplex/SBFD.

In one embodiment, each symbol in the reference time-domain resource set is used for full duplex/SBFD.

In one embodiment, the first information block indicates a type of a symbol comprised in the reference time-domain resource set.

In one embodiment, the first information block configures symbols in the reference time-domain resource set as first type.

In one embodiment, the first type is different from uplink and downlink.

In one embodiment, the first type is different from uplink, downlink and Flexible.

In one embodiment, the first type is different from sidelink.

In one embodiment, the first information block indicates the reference time-domain resource set by configuring symbols in the reference time-domain resource set as the first type.

In one embodiment, a first RS resource is any RS resource in the first RS resource set.

In one embodiment, a first RS resource is CSI-RS resources in the first RS resource set.

In one embodiment, a first RS resource is any CSI-RS resource in the first RS resource set.

In one embodiment, a transmission occasion of any RS resource in the first RS resource set used for the radio link quality measurement depends on the reference time-domain resource set.

In one embodiment, a transmission occasion of any CSI-RS resource in the first RS resource set used for the radio link quality measurement depends on the reference time-domain resource set.

In one embodiment, the reference information block is used to determine a first RS resource set used for radio link quality measurement of a first BWP.

In one embodiment, a transmission occasion of any RS resource in the first RS resource set used for the radio link quality measurement of the first BWP depends on the reference time-domain resource set.

In one embodiment, a transmission occasion of any CSI-RS resource in the first RS resource set used for the radio link quality measurement of the first BWP depends on the reference time-domain resource set.

In one embodiment, the radio link quality is RSRP.

In one embodiment, the radio link quality is L1-RSRP.

In one embodiment, the radio link quality is SINR.

In one embodiment, the radio link quality is L1-SINR.

In one embodiment, the radio link quality is BLER.

In one embodiment, the radio link quality is hypothetical BLER.

In one embodiment, the radio link quality is one of RSRP (Reference Signal Received Power), L1-RSRP (Layer1-RSRP), SINR (Signal to Interference plus Noise Ratio), or L1-SINR (Layer1-SINR).

In one embodiment, a measurement on the first RS resource in an evaluation period is used for a radio link quality evaluation: the result of the radio link quality evaluation refers to whether the radio link quality is worse than a threshold, or the result of the radio link quality evaluation refers to whether the radio link quality is greater than a threshold, or the result of the radio link quality evaluation refers to whether the radio link quality is equal to or greater than a threshold.

In one embodiment, a measurement on the first RS resource in an evaluation period is used for a radio link quality evaluation, and the result of the radio link quality evaluation refers to whether the radio link quality is worse than a threshold.

In one embodiment, a measurement on the first RS resource in an evaluation period is used for a radio link quality evaluation, and the result of the radio link quality evaluation refers to whether the radio link quality is greater than a threshold.

In one embodiment, a measurement on the first RS resource in an evaluation period is used for a radio link quality evaluation, and the result of the radio link quality evaluation refers to whether the radio link quality is equal to or greater than a threshold.

In one embodiment, the result of the radio link quality evaluation refers to whether a new candidate beam is found.

In one embodiment, the result of the radio link quality evaluation refers to whether to transmit an indication to higher layer.

In one embodiment, the result of the radio link quality evaluation refers to whether to transmit a beam failure instance indication to higher layer.

In one embodiment, the result of the radio link quality evaluation refers to whether to transmit an in-sync indication to higher layer.

In one embodiment, the result of the radio link quality evaluation refers to whether to transmit an out-of-sync indication to higher layer.

In one embodiment, at least one transmission occasion of the first RS resource overlaps with the reference time-domain resource set.

In one embodiment, only when at least one transmission occasion of the first RS resource overlaps with the reference time-domain resource set, a transmission occasion of the first RS resource used for the radio link quality measurement depends on the reference time-domain resource set.

In one embodiment, a transmission occasion of the first RS resource being overlapping with the reference time-domain resource set refers to: a transmission occasion of the first RS resource belongs to the reference time-domain resource set.

In one embodiment, a transmission occasion of the first RS resource being overlapping with the reference time-domain resource set refers to: a transmission occasion of the first RS resource comprises time-domain resources in the reference time-domain resource set.

In one embodiment, a transmission occasion of the first RS resource being overlapping with the reference time-domain resource set refers to: a transmission occasion of the first RS resource comprises at least one symbol in the reference time-domain resource set.

In one embodiment, a transmission occasion of the first RS resource being overlapping with the reference time-domain resource set refers to: a transmission occasion of the first RS resource partially or completely overlaps with the reference time-domain resource set.

In one embodiment, any transmission occasion of the first RS resource used for the radio link quality measurement is overlapping with the reference time-domain resource set.

In one embodiment, any transmission occasion of the first RS resource used for the radio link quality measurement belongs to the reference time-domain resource set.

In one embodiment, “a transmission occasion of the first RS resource used for the radio link quality measurement depends on the reference time-domain resource set” comprises: in an evaluation period, an evaluation of which transmission occasion(s) of the first RS resource is (are) measured by radio link quality depends on the reference time-domain resource set.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the first node in the present application comprises the UE 241.

In one embodiment, the second node in the present application comprises the gNB 203.

### Embodiment 3

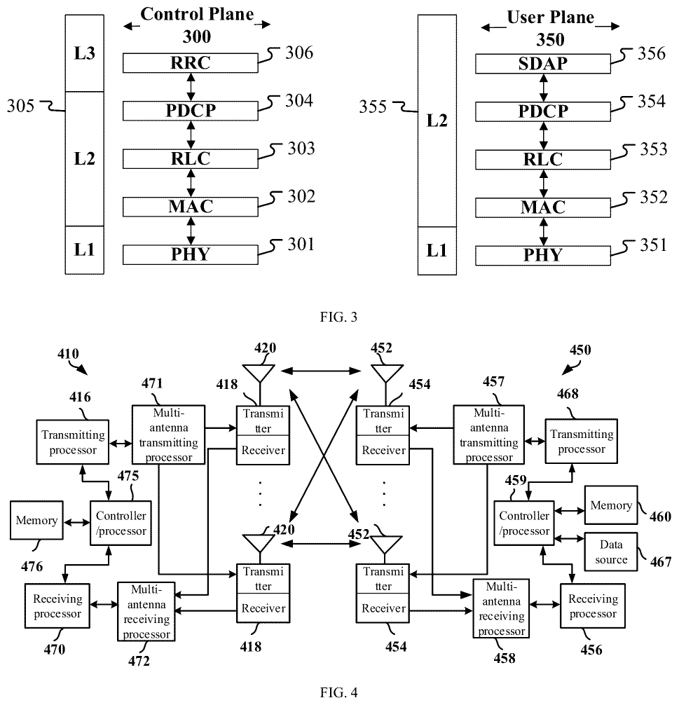

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the reference information block is generated by the RRC sublayer 306.

In one embodiment, the first information block is generated by the RRC sublayer 306.

In one embodiment, the first information block is generated by the MAC sublayer 302 or the MAC sublayer 352.

In one embodiment, the first information block is generated by the PHY 301 or the PHY 351.

In one embodiment, the higher layer in the present application refers to a layer above the physical layer.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DownLink) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes: the at least one memory and the computer program codes are configured to be used in collaboration with the at least one processor. The second communication device 450 at least: receives a reference information block and a first information block; herein, the reference information block is used to determine a first RS resource set used for a radio link quality measurement, and the first RS resource set comprises at least one RS resource: the first information block is used to determine a reference time-domain resource set: a first RS resource is an RS resource in the first RS resource set, and a transmission occasion of the first RS resource used for the radio link quality measurement depends on the reference time-domain resource set.

In one embodiment, the second communication device 450 comprises a memory that stores a computer readable instruction program. The computer readable instruction program generates an action when executed by at least one processor. The action includes: receiving a reference information block and a first information block; herein, the reference information block is used to determine a first RS resource set used for a radio link quality measurement, and the first RS resource set comprises at least one RS resource: the first information block is used to determine a reference time-domain resource set: a first RS resource is an RS resource in the first RS resource set, and a transmission occasion of the first RS resource used for the radio link quality measurement depends on the reference time-domain resource set.

In one embodiment, the first communication device 410 comprises at least one processor and at least one memory. The at least one memory comprises computer program codes: the at least one memory and the computer program codes are configured to be used in collaboration with the at least one processor. The first communication device 410 at least: transmits a reference information block and a first information block: herein, the reference information block is used to determine a first RS resource set used for a radio link quality measurement, and the first RS resource set comprises at least one RS resource: the first information block is used to determine a reference time-domain resource set: a first RS resource is an RS resource in the first RS resource set, and a transmission occasion of the first RS resource used for the radio link quality measurement depends on the reference time-domain resource set.

In one embodiment, the first communication device 410 comprises a memory that stores a computer readable instruction program. The computer readable instruction program generates an action when executed by at least one processor. The action includes: transmitting a reference information block and a first information block: herein, the reference information block is used to determine a first RS resource set used for a radio link quality measurement, and the first RS resource set comprises at least one RS resource: the first information block is used to determine a reference time-domain resource set: a first RS resource is an RS resource in the first RS resource set, and a transmission occasion of the first RS resource used for the radio link quality measurement depends on the reference time-domain resource set.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the reference information block in the present application: at least one of the antenna 420, the transmitter 418, the transmitting processor 416, the multi-antenna transmitting processor 471, the controller/processor 475, or the memory 476 is used to transmit the reference information block in the present application.

In one embodiment, at least one of the antenna 452, the receiver 454, the receiving processor 456, the multi-antenna receiving processor 458, the controller/processor 459, the memory 460, or the data source 467 is used to receive the first information block in the present application; at least one of the antenna 420, the transmitter 418, the transmitting processor 416, the multi-antenna transmitting processor 471, the controller/processor 475, or the memory 476 is used to transmit the first information block in the present application.

### Embodiment 5

Embodiment 5 illustrates a flowchart of wireless transmission according to one embodiment in the present application, as shown in FIG. 5. In FIG. 5, a first node U1 and a second node N2 are respectively two communication nodes transmitted via an air interface.

The first node U1 receives a reference information block in step S5101; receives a first information block in step S5102;

The second node N2 transmits a reference information block in step S5201; transmits a first information block in step S5202.

In embodiment 5, the reference information block is used to determine a first RS resource set used for a radio link quality measurement, and the first RS resource set comprises at least one RS resource; the first information block is used to determine a reference time-domain resource set; a first RS resource is an RS resource in the first RS resource set, and a transmission occasion of the first RS resource used for the radio link quality measurement depends on the reference time-domain resource set.

In one embodiment, the first node U2 is the first node in the present application.

In one embodiment, the second node N2 is the second node in the present application.

In one embodiment, an air interface between the second node N2 and the first node U1 comprises a radio interface between a base station and a UE.

In one embodiment, an air interface between the second node N2 and the first node U1 comprises a radio interface between a relay node and a UE.

In one embodiment, an air interface between the second node N2 and the first node U1 comprises a radio interface between a UE and a UE.

In one embodiment, a physical channel occupied by the reference information block comprises a PDSCH (Physical Downlink Shared Channel).

In one embodiment, a physical channel occupied by the first information block comprises a PDSCH (Physical Downlink Shared Channel).

In one embodiment, a physical layer channel occupied by the first information block comprises a PDCCH (Physical Downlink Control Channel).

In one embodiment, a reception of the reference information block is earlier than a reception of the first information block.

In one embodiment, a reception of the reference information block is not earlier than a reception of the first information block.

### Embodiments 6A-6C

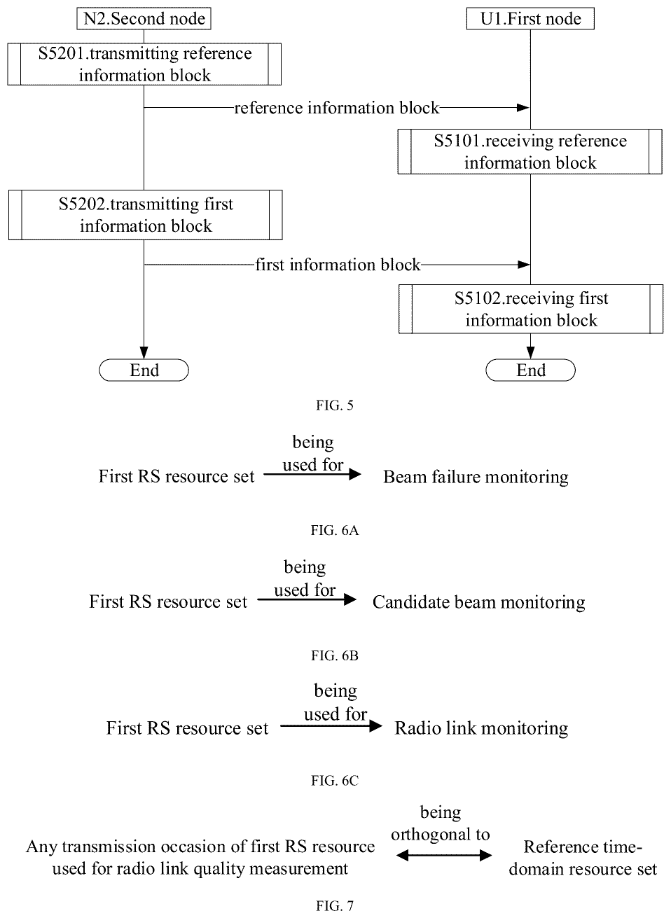

Embodiments. 6A-6C respectively illustrate a schematic diagram of a first RS resource set according to one embodiment of the present application, as shown in FIGS. 6A-6C.

In Embodiment 6A, the first RS resource set is used for Beam Failure Detection (BFD).

In one embodiment, the reference information block is used to determine a first RS resource set used for radio link quality measurement of a first BWP.

In one embodiment, the first RS resource set is used for radio link quality measurement of a first BWP.

In one embodiment, the first RS resource set is used for radio link quality measurement of a first serving cell.

In one embodiment, the first RS resource set is used for a radio link quality evaluation of the first BWP.

In one embodiment, the first RS resource set is used for a radio link quality evaluation of the first serving cell.

In one embodiment, the first RS resource set is used for failure monitoring.

In one embodiment, the first RS resource set comprises at one periodic CSI-RS resource.

In one embodiment, the first RS resource set comprises one or two of periodic CSI-RS resources and an SS/PBCH block.

In one embodiment, the first RS resource set is q̅₀.

In one embodiment, the first RS resource set is q̅_{0,0}.

In one embodiment, the first RS resource set is q̅_{0,1}.

In one embodiment, for specific definitions of q̅₀, q̅_{0,0} and q̅_{0,1}, refer to chapter 6 in 3GPP TS38.213.

In one embodiment, the reference information block indicates the first RS resource set.

In one embodiment, the reference information block comprises partial fields in an RRC IE.

In one embodiment, the reference information block comprises a higher-layer parameter FailureDetectionResources ToAddModList.

In one embodiment, the reference information block comprises partial fields in an IE RadioLinkMonitoringConfig.

In one embodiment, the reference information block comprises a failureDetectionResourcesToAddModList field in an IE RadioLinkMonitoringConfig.

In one embodiment, the reference information block comprises a RadioLinkMonitoringRS field in an IE RadioLinkMonitoringConfig.

In one embodiment, the reference information block comprises at least one RadioLinkMonitoringRS field in an IE RadioLinkMonitoringConfig.

In one embodiment, the reference information block comprises at least one RadioLinkMonitoringRS field in an IE RadioLinkMonitoringConfig, and a parameter purpose in the at least one RadioLinkMonitoringRS field is set as beamFailure or both.

In one embodiment, for the specific definition of IE RadioLinkMonitoringConfig, refer to chapter 6.3.2 of 3GPP TS38.331.

In one embodiment, the reference information block is used to configure a first CORESET pool on a first BWP, and the first CORESET pool comprises at least one CORESET; the first RS resource set depends on at least one TCI state of at least one CORESET in the first CORESET pool.

In one subembodiment of the above embodiment, the reference information block comprises partial fields in an IE PDCCH-Config.

In one subembodiment of the above embodiment, the reference information block comprises a controllResourceSetToAddModList field in an IE PDCCH-Config.

In one subembodiment of the above embodiment, the reference information block comprises a field whose name comprises controlResourceSetToAddModList in an IE PDCCH-Config.

In one subembodiment of the above embodiment, the reference information block comprises a field whose name comprises controlResourceSet in an IE PDCCH-Config.

In one embodiment, the meaning of the phrase that “the first RS resource set depends on at least one TCI state of at least one CORESET in the first CORESET pool” comprises: the first RS resource set is determined according to an RS index of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to an RS index configured with QCL type ‘typeD’ in at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises an RS resource configured with QCL type ‘typeD’ in at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to a periodic CSI-RS resource configuration index with a same value as an RS index of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to a periodic CSI-RS resource configuration index with a same value as an RS index configured with QCL type ‘typeD’ in at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to a periodic CSI-RS resource configuration index with a same value as an RS index of at least one RS resource indicated by at least one TCI state of at least one CORESET in the first CORESET pool; for a TCI state indicating multiple RS resources in at least one TCI state in at least one CORESET in the first CORESET, the first RS resource set only comprises RS resources configured with QCL type ‘typeD’.

In one embodiment, the meaning of the phrase that “the first RS resource set depends on at least one TCI state of at least one CORESET in the first CORESET pool” comprises: the first RS resource set comprises at least one periodic CSI-RS resource, and an index of the at least one periodic CSI-RS resource is the same as an RS index of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises at least one periodic CSI-RS resource, and an index of the at least one periodic CSI-RS resource is the same as an RS index configured with QCL type ‘typeD’ of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises at least one periodic CSI-RS resource, and an index of the at least one periodic CSI-RS resource is the same as an RS index of at least one RS resource indicated by at least one TCI state of at least one CORESET in the first CORESET pool: for a TCI state indicating multiple RS resources in at least one TCI state in at least one CORESET in the first CORESET, the first RS resource set only comprises RS resources configured with QCL type ‘typeD’.

In one embodiment, the meaning of the phrase that “the first RS resource set depends on at least one TCI state of at least one CORESET in the first CORESET pool” comprises: the first RS resource set is determined according to an SS/PBCH block index with a same value as an RS index of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to an SS/PBCH block index with a same value as an RS index configured with QCL type ‘typeD’ in at least one RS indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to an SS/PBCH block index with a same value as an RS index of at least one RS resource indicated by at least one TCI state of at least one CORESET in the first CORESET pool: for a TCI state indicating multiple RS resources in at least one TCI state in at least one CORESET in the first CORESET, the first RS resource set only comprises RS resources configured with QCL type ‘typeD’.

In one embodiment, the meaning of the phrase that “the first RS resource set depends on at least one TCI state of at least one CORESET in the first CORESET pool” comprises: the first RS resource set comprises at least one SS/PBCH block, and an index of the at least one SS/PBCH block is the same as an RS index of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises at least one SS/PBCH block, and an index of the at least one SS/PBCH block is the same as an RS index configured with QCL type ‘typeD’ of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises at least one SS/PBCH block, and an index of the at least one SS/PBCH block is the same as an RS index of at least one RS resource indicated by at least one TCI state of at least one CORESET in the first CORESET pool; for a TCI state indicating multiple RS resources in at least one TCI state in at least one CORESET in the first CORESET, the first RS resource set only comprises RS resources configured with QCL type ‘typeD’.

In one embodiment, the meaning of the phrase that “an index of the at least one periodic CSI-RS resource is the same as an RS index of at least one RS resource indicated by at least one TCI state of at least one CORESET in the first CORESET pool” comprises: an index of the at least one periodic CSI-RS resource comprises at least one RS index in at least one TCI state indicated by at least one CORESET in the first CORESET pool.

In one embodiment, the meaning of the phrase that “an index of the at least one periodic CSI-RS resource is the same as an RS index of at least one RS resource indicated by at least one TCI state of at least one CORESET in the first CORESET pool” comprises: an index of the at least one periodic CSI-RS resource comprises an RS index configured with QCL type ‘typeD’ in at least one RS indicated by at least one TCI state of at least one CORESET in the first CORESET pool.

In one embodiment, the meaning of the phrase that “an index of the at least one periodic CSI-RS resource is the same as an RS index of at least one RS resource indicated by at least one TCI state of at least one CORESET in the first CORESET pool” comprises: an index of at least one periodic CSI-RS resource is the same as an RS index configured with QCL type ‘typeD’ in at least one RS indicated by at least one TCI state of at least one CORESET in the first CORESET pool.

In one embodiment, the meaning of the phrase that “an index of the at least one periodic CSI-RS resource is the same as an RS index of at least one RS resource indicated by at least one TCI state of at least one CORESET in the first CORESET pool” comprises: an index of any periodic CSI-RS resource in the at least one periodic CSI-RS resource is the same as an RS index indicated by one TCI state in at least one TCI state of at least one CORESET in the first CORESET pool, and an RS index indicated by any TCI state in at least one TCI state of at least one CORESET in the first CORESET pool is the same as an index of a periodic CSI-RS resource in the first RS resource set.

In one embodiment, an index of a CSI-RS resource is a CSI-RS resource configuration index.

In one embodiment, an index of a CSI-RS resource is used to identify the CSI-RS resource.

In one embodiment, an index of a CSI-RS resource is used to identify a configuration of the CSI-RS resource.

In one embodiment, the meaning of the phrase that “an index of the at least one SS/PBCH block is the same as an RS index of at least one RS resource indicated by at least one TCI state of at least one CORESET in the first CORESET pool” comprises: an index of the at least one SS/PBCH block comprises at least one RS index in at least one RS indicated by at least one TCI state of at least one CORESET in the first CORESET pool.

In one embodiment, the meaning of the phrase that “an index of the at least one SS/PBCH block is the same as an RS index of at least one RS resource indicated by at least one TCI state of at least one CORESET in the first CORESET pool” comprises: an index of the at least one SS/PBCH block comprises an RS index configured with QCL type ‘typeD’ in at least one RS indicated by at least one TCI state of at least one CORESET in the first CORESET pool.

In one embodiment, the meaning of the phrase that “an index of the at least one SS/PBCH block is the same as an RS index of at least one RS resource indicated by at least one TCI state of at least one CORESET in the first CORESET pool” comprises: an index of the at least one SS/PBCH block is the same as an RS index configured with QCL type ‘typeD’ in at least one RS indicated by at least one TCI state of at least one CORESET in the first CORESET pool.

In one embodiment, the meaning of the phrase that “an index of the at least one SS/PBCH block is the same as an RS index of at least one RS resource indicated by at least one TCI state of at least one CORESET in the first CORESET pool” comprises: an index of any SS/PBCH block in the at least one SS/PBCH block is the same as an RS index indicated by one TCI state in at least one TCI state of at least one CORESET in the first CORESET pool, and an RS index indicated by any TCI state in at least one TCI state of at least one CORESET in the first CORESET pool is the same as an index of an SS/PBCH block in the first RS resource set.

In one embodiment, an index of an SS/PBCH block is used to identify the SS/PBCH block.

In one embodiment, an index of an SS/PBCH block is used to identify a configuration of the SS/PBCH block.

In one embodiment, an index of a CSI-RS resource is an NZP-CSI-RS-ResourceId.

In one embodiment, an index of an SS/PBCH block is SSB-Index.

In one embodiment, for specific procedure of beam failure monitoring, refer to chapter 6 of 3GPP TS38.213.

In one embodiment, for specific procedure of beam failure monitoring, refer to chapter 5.17 of 3GPP TS38.321.

In embodiment 6B, the first RS resource set is used for candidate beam monitoring.

In one embodiment, the first RS resource set comprises at one candidate beam RS resource.

In one embodiment, the first RS resource set is used for a candidate beam detection.

In one embodiment, the first RS resource set is used for Link Recovery.

In one embodiment, the first RS resource set is used for Beam Failure Recovery (BFR).

In one embodiment, the first RS resource set is used to select a new candidate beam from the first RS resource set in beam failure recovery.

In one embodiment, the reference information block comprises one of a higher-layer parameter candidateBeamRSList, candidateBeamRSListExt, or the candidateBeamRSSCellList.

In one embodiment, a name of the reference information block comprises candidateBeam.

In one embodiment, the first RS resource set comprises at one periodic CSI-RS resource.

In one embodiment, the first RS resource set comprises one or two of a periodic CSI-RS resource and an SS/PBCH block.

In one embodiment, the first RS resource set is q̅₁.

In one embodiment, the first RS resource set is q̅_{1,0}.

In one embodiment, the first RS resource set is q̅_{1,1}.

In one embodiment, for specific definitions of q̅₁, q̅_{1,0} and q̅_{1,1}, refer to chapter 6 in 3GPP TS38.213.

In one embodiment, for specific definitions of candidate beam monitoring and beam failure recovery, refer to chapter 6 of 3GPP TS38.213.

In one embodiment, for specific definitions of candidate beam monitoring and beam failure recovery, refer to chapter 5.17 of 3GPP TS38.321.

In one embodiment, for specific definitions of candidateBeamRSList, candidateBeamRSListExt and candidateBeamRSSCellList, refer to chapter 6 in 3GPP TS38.213.

In embodiment 6C, the first RS resource set is used for Radio Link Monitoring (RLM).

In one embodiment, the reference information block is used to configure a first CORESET pool on a first BWP, and the first CORESET pool comprises at least one CORESET: the first RS resource set depends on at least one TCI state of at least one CORESET in the first CORESET pool.

In one embodiment, the reference information block is used to configure a first CORESET pool on a first BWP, and the first CORESET pool comprises at least one CORESET: the first RS resource set comprises at least one RS resource comprised in a TCI state received by PDCCH in at least one CORESET in the first CORESET pool.

In one embodiment, the first BWP is an active DL (Down Link) BWP.

In one embodiment, the first BWP is an active DL BWP of a first serving cell.

In one subembodiment of the above embodiment, the reference information block comprises a controllResourceSetToAddModList field in an IE PDCCH-Config.

In one subembodiment of the above embodiment, the reference information block comprises a field whose name comprises controlResourceSetToAddModList in an IE PDCCH-Config.

In one subembodiment of the above embodiment, the reference information block comprises a field whose name comprises controlResourceSet in an IE PDCCH-Config.

In one embodiment, the meaning of the phrase that “the first RS resource set depends on at least one TCI state of at least one CORESET in the first CORESET pool” comprises: the first RS resource set is determined according to an RS index of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to an RS index configured with QCL type ‘typeD’ in at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises an RS resource configured with QCL type ‘typeD’ in at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to a periodic CSI-RS resource configuration index with a same value as an RS index of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to a periodic CSI-RS resource configuration index with a same value as an RS index configured with QCL type ‘typeD’ in at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to a periodic CSI-RS resource configuration index with a same value as an RS index of at least one RS resource indicated by at least one TCI state of at least one CORESET in the first CORESET pool: for a TCI state indicating multiple RS resources in at least one TCI state in at least one CORESET in the first CORESET pool, the first RS resource set only comprises RS resources configured with QCL type ‘typeD’.

In one embodiment, the meaning of the phrase that “the first RS resource set depends on at least one TCI state of at least one CORESET in the first CORESET pool” comprises: the first RS resource set comprises at least one periodic CSI-RS resource, and an index of the at least one periodic CSI-RS resource is the same as an RS index of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises at least one periodic CSI-RS resource, and an index of the at least one periodic CSI-RS resource is the same as an RS index configured with QCL type ‘typeD’ of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises at least one periodic CSI-RS resource, and an index of the at least one periodic CSI-RS resource is the same as an RS index of at least one RS resource indicated by at least one TCI state of at least one CORESET in the first CORESET pool: for a TCI state indicating multiple RS resources in at least one TCI state in at least one CORESET in the first CORESET, the first RS resource set only comprises RS resources configured with QCL type ‘typeD’.

In one embodiment, the meaning of the phrase that “the first RS resource set depends on at least one TCI state of at least one CORESET in the first CORESET pool” comprises: the first RS resource set is determined according to an SS/PBCH block index with a same value as an RS index of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to an SS/PBCH block index with a same value as an RS index configured with QCL type ‘typeD’ in at least one RS indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set is determined according to an SS/PBCH block index with a same value as an RS index of at least one RS resource indicated by at least one TCI state of at least one CORESET in the first CORESET pool: for a TCI state indicating multiple RS resources in at least one TCI state in at least one CORESET in the first CORESET, the first RS resource set only comprises RS resources configured with QCL type ‘typeD’.

In one embodiment, the meaning of the phrase that “the first RS resource set depends on at least one TCI state of at least one CORESET in the first CORESET pool” comprises: the first RS resource set comprises at least one SS/PBCH block, and an index of the at least one SS/PBCH block is the same as an RS index of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises at least one SS/PBCH block, and an index of the at least one SS/PBCH block is the same as an RS index configured with QCL type ‘typeD’ of at least one RS resource indicated by at least one TCI state of at least one CORESET in the first CORESET pool.

In one embodiment, the meaning of the phrase that “the first RS resource set depends on at least one TCI state of at least one CORESET in the first CORESET pool” comprises: the first RS resource set comprises at least one SS/PBCH block, and an index of the at least one SS/PBCH block is the same as an RS index of at least one RS resource indicated by at least one TCI state of at least one CORESET in the first CORESET pool; for a TCI state indicating multiple RS resources in at least one TCI state in at least one CORESET in the first CORESET, the first RS resource set only comprises RS resources configured with QCL type ‘typeD’.

In one embodiment, the meaning of the phrase that “an index of the at least one periodic CSI-RS resource is the same as an RS index of at least one RS resource indicated by at least one TCI state of at least one CORESET in the first CORESET pool” comprises: an index of the at least one periodic CSI-RS resource comprises at least one RS index in at least one RS indicated by at least one TCI state in at least one CORESET in the first CORESET pool.

In one embodiment, the meaning of the phrase that “an index of the at least one periodic CSI-RS resource is the same as an RS index of at least one RS resource indicated by at least one TCI state of at least one CORESET in the first CORESET pool” comprises: an index of the at least one periodic CSI-RS resource comprises an RS index configured with QCL type ‘typeD’ in at least one RS indicated by at least one TCI state of at least one CORESET in the first CORESET pool.

In one embodiment, the meaning of the phrase that “an index of the at least one periodic CSI-RS resource is the same as an RS index of at least one RS resource indicated by at least one TCI state of at least one CORESET in the first CORESET pool” comprises: an index of at least one periodic CSI-RS resource is the same as an RS index configured with QCL type ‘typeD’ in at least one RS indicated by at least one TCI state of at least one CORESET in the first CORESET pool.

In one embodiment, the meaning of the phrase that “an index of the at least one periodic CSI-RS resource is the same as an RS index of at least one RS resource indicated by at least one TCI state of at least one CORESET in the first CORESET pool” comprises: an index of any periodic CSI-RS resource in the at least one periodic CSI-RS resource is the same as an RS index of one TCI state indicated by at least one TCI state of at least one CORESET in the first CORESET pool, and an RS index indicated by any TCI state in at least one TCI state of at least one CORESET in the first CORESET pool is the same as an index of one periodic CSI-RS resource in the first RS resource set.

In one embodiment, an index of a CSI-RS resource is a CSI-RS resource configuration index.

In one embodiment, an index of a CSI-RS resource is used to identify the CSI-RS resource.

In one embodiment, an index of a CSI-RS resource is used to identify a configuration of the CSI-RS resource.

In one embodiment, the meaning of the phrase that “an index of the at least one SS/PBCH block is the same as an RS index of at least one RS resource indicated by at least one TCI state of at least one CORESET in the first CORESET pool” comprises: an index of the at least one SS/PBCH block comprises at least one RS index in at least one RS indicated by at least one TCI state in at least one CORESET in the first CORESET pool.

In one embodiment, the meaning of the phrase that “an index of the at least one SS/PBCH block is the same as an RS index of at least one RS resource indicated by at least one TCI state of at least one CORESET in the first CORESET pool” comprises: an index of the at least one SS/PBCH block comprises an RS index configured with QCL type ‘typeD’ in at least one RS indicated by at least one TCI state of at least one CORESET in the first CORESET pool.

In one embodiment, the meaning of the phrase that “an index of the at least one SS/PBCH block is the same as an RS index of at least one RS resource indicated by at least one TCI state of at least one CORESET in the first CORESET pool” comprises: an index of the at least one SS/PBCH block is the same as an RS index configured with QCL type ‘typeD’ in at least one RS indicated by at least one TCI state of at least one CORESET in the first CORESET pool.

In one embodiment, the meaning of the phrase that “an index of the at least one SS/PBCH block is the same as an RS index of at least one RS resource indicated by at least one TCI state of at least one CORESET in the first CORESET pool” comprises: an index of any SS/PBCH block in the at least one SS/PBCH block is the same as an RS index indicated by one TCI state in at least one TCI state of at least one CORESET in the first CORESET pool, and an RS index indicated by any TCI state in at least one TCI state of at least one CORESET in the first CORESET pool is the same as an index of an SS/PBCH block in the first RS resource set.

In one embodiment, an index of an SS/PBCH block is used to identify the SS/PBCH block.

In one embodiment, an index of an SS/PBCH block is used to identify a configuration of the SS/PBCH block.

In one embodiment, an index of a CSI-RS resource is an NZP-CSI-RS-ResourceId.

In one embodiment, an index of an SS/PBCH block is SSB-Index.

In one embodiment, the radio link quality is used to evaluate in-sync or out-of-sync state.

In one embodiment, the radio link quality is monitored by the first node to indicate an in-sync/out-of-sync state to its higher layer.

In one embodiment, the first RS resource set is used to monitor Radio Link Failure (RLF).

In one embodiment, the reference information block is used to determine a first RS resource set used for radio link quality measurement of a first serving cell.

In one embodiment, the first serving cell is a Special Cell (SpCell).

In one embodiment, the first serving cell is a Primary Cell (PCell).

In one embodiment, the first serving cell is a PSCell (Primary secondary cell).

In one embodiment, the first RS resource set comprises at one RLM-RS resource.

In one embodiment, the first RS resource set comprises one or two of a periodic CSI-RS resource and an SS/PBCH block.

In one embodiment, the first RS resource set comprises at least one SS/PBCH block resource.

Typically, SS/PBCH block resources are equivalent to SSB resources.

In one embodiment, the reference information block comprises a higher-layer parameter RadioLinkMonitoringRS.

In one embodiment, the reference information block comprises a higher-layer parameter FailureDetectionResources ToAddModList.

In one embodiment, the reference information block comprises partial fields in an RRC IE.

In one embodiment, the reference information block comprises partial fields in an IE RadioLinkMonitoringConfig.

In one embodiment, the reference information block comprises a failureDetection Resources ToAddModList field in an IE RadioLinkMonitoringConfig.

In one embodiment, the reference information block comprises a RadioLinkMonitoringRS field in an IE RadioLinkMonitoringConfig.

In one embodiment, the reference information block comprises at least one RadioLinkMonitoringRS field in an IE RadioLinkMonitoringConfig.

In one embodiment, the reference information block comprises at least one RadioLinkMonitoringRS field in an IE RadioLinkMonitoringConfig, and a parameter purpose in the at least one Radio LinkMonitoringRS field is set as rlf or both.

In one embodiment, for the specific definition of Radio Link Monitoring, refer to chapter 5 of 3GPP TS38.213.

### Embodiment 7

Embodiment 7 illustrates a schematic diagram of relations between a transmission occasion of a first RS resource and a reference time-domain resource set according to one embodiment of the present application; as shown in FIG. 7.

In embodiment 7, any transmission occasion of the first RS resource used for the radio link quality measurement is orthogonal to the reference time-domain resource set.

In one embodiment, any transmission occasion of the first RS resource used by the first node for the radio link quality measurement is orthogonal to the reference time-domain resource set.

In one embodiment, a transmission occasion of the first RS resource used for the radio link quality measurement of the first BWP is orthogonal to the reference time-domain resource set.

In one embodiment, the meaning of “any transmission occasion of the first RS resource used by the first node for the radio link quality measurement is orthogonal to the reference time-domain resource set” comprises: any transmission occasion of the first RS resource not orthogonal to the reference time-domain resource set is not used by the first node for the radio link quality measurement.

In one embodiment, the meaning of “any transmission occasion of the first RS resource used by the first node for the radio link quality measurement is orthogonal to the reference time-domain resource set” comprises: a transmission occasion of the first RS resource that is only orthogonal to the reference time-domain resource set is used by the first node for the radio link quality measurement.

In one embodiment, the meaning that “a transmission occasion is orthogonal to the reference time-domain resource set” comprises: the transmission occasion does not comprise the reference time-domain resource set.

In one embodiment, the meaning that “a transmission occasion is orthogonal to the reference time-domain resource set” comprises: the transmission occasion does not belong to the reference time-domain resource set.

In one embodiment, the meaning that “a transmission occasion is orthogonal to the reference time-domain resource set” comprises: the transmission occasion does not comprise any symbol in the reference time-domain resource set.

In one embodiment, the meaning that “a transmission occasion is orthogonal to the reference time-domain resource set” comprises: the transmission occasion does not comprise time-domain resources in the reference time-domain resource set.

In one embodiment, the meaning that “a transmission occasion is orthogonal to the reference time-domain resource set” comprises: the transmission occasion is not comprised in the reference time-domain resource set.

In one embodiment, the meaning that “a transmission occasion is orthogonal to the reference time-domain resource set” comprises: the transmission occasion does not overlap with the reference time-domain resource set.

### Embodiment 8

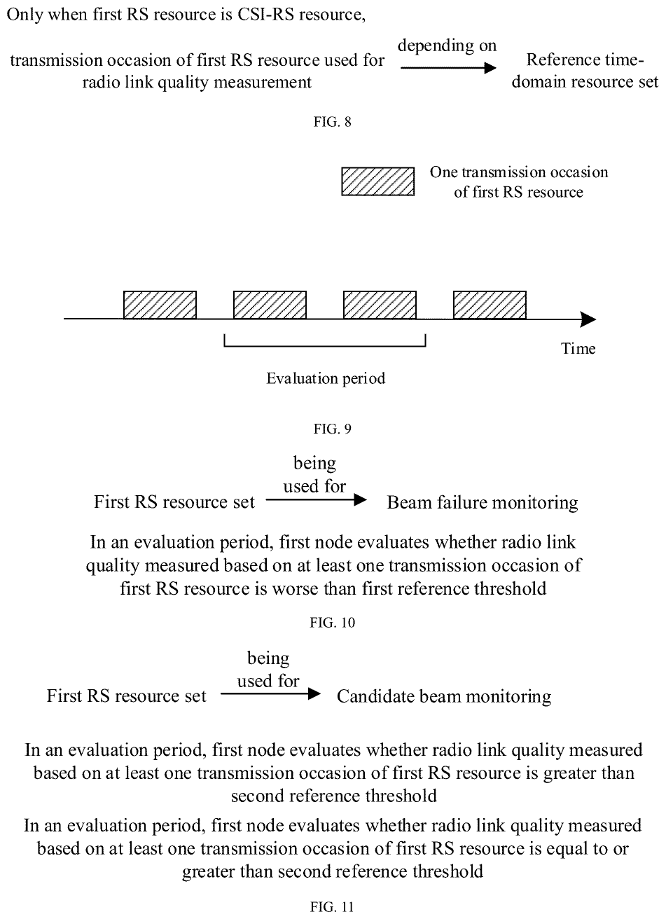

Embodiment 8 illustrates a schematic diagram of a first RS resource according to one embodiment of the present application, as shown in FIG. 8.

In embodiment 8, only when the first RS resource is a CSI-RS resource, a transmission occasion of the first RS resource used for the radio link quality measurement depends on the reference time-domain resource set.

In one embodiment, only when the first RS resource is a periodic CSI-RS resource, a transmission occasion of the first RS resource used for the radio link quality measurement depends on the reference time-domain resource set.

In one embodiment, only when the first RS resource is not an SS/PBCH block resource, a transmission occasion of the first RS resource used for the radio link quality measurement depends on the reference time-domain resource set.

In one embodiment, a transmission occasion of any RS resource in the first RS resource set that is not an SS/PBCH block resource used for the radio link quality measurement depends on the reference time-domain resource set.

In one embodiment, the first RS resource set comprises SS/PBCH block resources, and a transmission occasion of SS/PBCH block resources in the first RS resource set used for the radio link quality measurement is independent of the reference time-domain resource set.

In one embodiment, when the first RS resource is not a CSI-RS resource, a transmission occasion of the first RS resource used for the radio link quality measurement is independent of the reference time-domain resource set.

### Embodiment 9

Embodiment 9 illustrates a schematic diagram of an evaluation period and a transmission occasion of a first RS resource according to one embodiment of the present application, as shown in FIG. 9.

In embodiment 9, in an evaluation period, the first node evaluates radio link quality based on a measurement on at least one transmission occasion of the first RS resource; in an evaluation period, which transmission occasion(s) of the first RS resource is (are) measured for evaluating the radio link quality depends on the reference time-domain resource set.

In one embodiment, an evaluation period comprises a period of time.

In one embodiment, an evaluation period comprises a period of continuous time.

In one embodiment, multiple evaluation periods occur periodically.

In one embodiment, multiple evaluation periods occur aperiodically.

In one embodiment, the first RS resource is an SS/PBCH block resource, and the evaluation period is T_{Evaluate_out_SSB}.

In one embodiment, the first RS resource is a CSI-RS resource, and the evaluation period is T_{Evaluate_out CSI-RS}.

In one embodiment, the first RS resource is an SS/PBCH block resource, and the evaluation period is T_{Evaluate_in_SSB}.

In one embodiment, the first RS resource is a CSI-RS resource, and the evaluation period is T_{Evaluate_in_CSI-RS}.

In one embodiment, the first RS resource is an SS/PBCH block resource, and the evaluation period is T_{Evaluate_BFD_SSB}.

In one embodiment, the first RS resource is a CSI-RS resource, and the evaluation period is T_{Evaluate_BFD_CSI-RS}.

In one embodiment, the first RS resource is an SS/PBCH block resource, and the evaluation period is T_{Evaluate_CBD_SSB}.

In one embodiment, the first RS resource is a CSI-RS resource, and the evaluation period is T_{Evaluate_CBD_CSI-RS}.

In one embodiment, the evaluation period is T_{Evaluate_out_SSB} or T_{Evaluate_out CSI-RS}.

In one embodiment, the evaluation period is T_{Evaluate_in_SSB} or T_{Evaluate_in_CSI-RS}.

In one embodiment, the evaluation period is T_{Evaluate_BFD_SSB} Or T_{Evaluate_BFD_CSI-RS}.

In one embodiment, the evaluation period is T_{Evaluate_CBD_SSB} or T_{Evaluate_CBD_CSI-RS}.

In one embodiment, in an evaluation period, at least one transmission occasion of the first RS resource overlaps with the reference time-domain resource set, and which transmission occasion(s) of the first RS resource is (are) measured for evaluating the radio link quality depends on the reference time-domain resource set.

In one embodiment, in an evaluation period, only when at least one transmission occasion of the first RS resource overlaps with the reference time-domain resource set, and which transmission occasion(s) of the first RS resource is (are) measured for evaluating the radio link quality depends on the reference time-domain resource set.

In one embodiment, in the evaluation period, at least one transmission occasion of the first RS resource measured for evaluating the radio link quality is orthogonal to the reference time-domain resource set.

In one embodiment, “in an evaluation period, the first node evaluating radio link quality based on a measurement on at least one transmission occasion of the first RS resource” comprises: in an evaluation period, the first node shall be able to evaluate radio link quality based on a measurement on at least one transmission occasion of the first RS resource.

### Embodiment 10

Embodiment 10 illustrates a schematic diagram of relations among a first RS resource, radio link quality and a first reference threshold according to one embodiment of the present application, as shown in FIG. 10.

In embodiment 10, the first RS resource set is used for beam failure monitoring: in an evaluation period, the first node evaluates whether radio link quality measured based on at least one transmission occasion of the first RS resource is worse than a first reference threshold.

In one embodiment, a measurement on the first RS resource in an evaluation period is used for a radio link quality evaluation, and the result of the radio link quality evaluation refers to whether the radio link quality is worse than a first reference threshold; the result of the radio link quality evaluation refers to whether to transmit a beam failure instance indication to higher layer.

In one embodiment, the radio link quality is L1-RSRP (Layer1 Reference Signal Received Power) or L1-SINR (Layer1 Signal to Interference plus Noise Ratio); when the radio link quality is less than the first reference threshold, the radio link quality is worse than the first reference threshold; when the radio link quality is equal to or greater than the first reference threshold, the radio link quality is not worse than the first reference threshold.

In one embodiment, the radio link quality is BLER (Block Error Rate); when the radio link quality is greater than the first reference threshold, the radio link quality is worse than the first reference threshold; when the radio link quality is less than or equal to the first reference threshold, the radio link quality is not worse than the first reference threshold.

In one embodiment, the first reference threshold is Q_{out_LR}.

In one embodiment, the first RS resource is an SS/PBCH block resource, and the first reference threshold is Q_{out_LR_SSB}.

In one embodiment, the first RS resource is a CSI-RS resource, and the first reference threshold is Q_{out_LR_CSI-RS}.

In one embodiment, the first reference threshold is configured by a parameter rlmInSyncOutOfSyncThreshold.

In one embodiment, for the specific definition of rlmInSyncOutOfSyncThreshold, refer to chapter 6 in 3GPP TS38.213.

In one embodiment, for the definition of rlmInSyncOutOfSync Threshold, refer to 3GPP TS38.133.

In one embodiment, the first reference threshold is a level at which a downlink radio level link of a given resource cannot be reliably received, the first reference threshold corresponds to a first target threshold, and the first target threshold is equal to 10% block error rate (BLER) of a hypothetical PDCCH transmission.

In one subembodiment of the above embodiment, the given resource configuration is the first resource.

In one embodiment, the meaning that “the first reference threshold correspond to a first target threshold” includes: the first target threshold is used to calculate the first reference threshold.

In one embodiment, the meaning that “the first reference threshold correspond to a first target threshold” includes: the first reference threshold is calculated by a formula, and the formula comprises the first target threshold.

In one embodiment, the meaning that “the first reference threshold correspond to a first target threshold” includes: a size of the first reference threshold changes with the first target threshold.

In one embodiment, the meaning that “the first reference threshold correspond to a first target threshold” includes: the first target threshold is used to determine a size of the first reference threshold, and a determination of the first reference threshold is indeed self-determined by the first node or implementation-related.

In one embodiment, the first RS resource is an SSB resource, the first reference threshold is Q_{out_LR_SSB}, and the first reference threshold is obtained based on hypothetical PDCCH transmission parameters.

In one embodiment, the first RS resource is a CSI-RS resource, the first reference threshold is Q_{out_LR_CSI-RS}, and the first reference threshold is obtained based on hypothetical PDCCH transmission parameters.

In one embodiment, the first BWP is a BWP of the first serving cell, and the first RS resource set is used for a radio link quality evaluation of the first BWP: when radio link quality evaluated according to all RS resources in the first RS resource set is worse than a first reference threshold, physical layer of the first node transmits a beam failure instance indication for the first serving cell to its higher layer.

Typically, physical layer of the first node is Layer 1.

In one embodiment, the first node comprises:
when a value of a target counter is equal to or greater than a target threshold, triggering beam failure recovery for a first serving cell;
wherein the first BWP is a BWP of the first serving cell: the first RS resource set is used for a radio link quality evaluation of the first BWP: when radio link quality evaluated according to all RS resources in the first RS resource set is worse than a first reference threshold, physical layer of the first node transmits a beam failure instance indication for the first serving cell to its higher layer: the target counter is used for counting the beam failure instance indication for the first serving cell.

Typically, the beam failure instance indication for a first serving cell is transmitted from the physical layer to its higher layer within the first node.

Typically, the beam failure recovery for the first serving cell is triggered by the first node in the present application.

Typically, the first serving cell is a serving cell where the first BWP is located.

Typically, the meaning of the phrase that “when a value of a target counter is equal to or greater than a target threshold” refers to: when and only when a value of the target counter is equal to or greater than a target threshold.

Typically, the meaning of the phrase that “when a value of a target counter is equal to or greater than a target threshold” refers to: as a response to a value of a target counter being equal to or greater than a target threshold.

Typically, the first node maintains the target counter at the MAC layer.

Typically, a MAC entity of the first node maintains the target counter.

Typically, when a MAC entity of the first node receives a beam failure instance indication for the first serving cell from physical layer, it starts or restarts a target timer, and a value of the target counter is incremented by 1.

Typically, the target counter is BFI-CONTER.

Typically, when the target timer expires, set the target counter to 0.

Typically, the target timer is beamFailureDetection Timer.

In one embodiment, the target counter is BFI_COUNTER.

In one embodiment, an initial value of the target counter is 0.

In one embodiment, the target threshold is a positive integer.

In one embodiment, the target threshold is beamFailureInstanceMaxCount.

In one embodiment, the target threshold is configured by RRC parameters.

In one embodiment, RRC parameters configuring the target threshold comprise all or partial information in a beamFailureInstanceMaxCount field of a RadioLinkMonitoring IE.

In one embodiment, the target timer is beamFailureDetection Timer.

In one embodiment, an initial value of the target timer is a positive integer.

In one embodiment, an initial value of the target timer is a positive real number.

In one embodiment, an initial value of the target counter is measured by Qout,LR reporting period of a beam failure detection RS.

In one embodiment, an initial value of the target timer is configured by a higher-layer parameter beam FailureDetection Timer.

In one embodiment, an initial value of the target timer is configured by an IE.

In one embodiment, a name of an IE configuring an initial value of the target timer comprises RadioLinkMonitoring.

In one embodiment, when beam failure recovery for the first serving cell is triggered, beam failure recovery procedureprocedure for the first serving cell comprises transmitting a first signal.

In one embodiment, the first signal comprises at least one of a content-based Random Access preamble, a BFR MAC CE, a Truncated BFR MAC CE, an Enhanced BFR MAC CE, or a Truncated Enhanced BFR MAC CE.

In one embodiment, the first signal comprises a random access preamble.

In one embodiment, the first signal comprises a contention-free Random Access Preamble.

In one embodiment, the BFR for the first serving cell comprises a random access procedure.

In one embodiment, the BFR for the first serving cell comprises at least one of transmitting a random access preamble, transmitting a BFR MAC CE, transmitting a Truncated BFR MAC CE, transmitting an Enhanced BFR MAC CE, or transmitting a Truncated Enhanced BFR MAC CE.

In one embodiment, the random access preamble is a contention-based Random Access Preamble.

In one embodiment, the random access preamble is a contention-free Random Access Preamble.

In one embodiment, the BFR for the first serving cell comprises transmitting one of a BFR MAC CE, a Truncated BFR MAC CE, an Enhanced BFR MAC CE, or a Truncated Enhanced BFR MAC CE.

In one embodiment, the BFR for the first serving cell comprises transmitting a MAC CE with a name comprising BFR.

In one embodiment, if the first node receives a response to the first signal, beam failure recovery for the first serving cell is successfully completed.

In one embodiment, the response for the first signal comprises an activation of a higher layer for a TCI state.

In one embodiment, the response for the first signal comprises an activation command of a higher-layer parameter tci-StatesPDCCH-ToAddList and/or tci-StatesPDCCH-ToReleaseList.

In one embodiment, the response to the first signal comprises a MAC CE used for indicating a PDCCH TCI.

In one embodiment, the response to the first signal comprises an RRC signaling used for configuring CORESET TCI-state.

In one embodiment, the response for the first signal comprises Downlink control information (DCI).

In one embodiment, the response to the first signal comprises a physical-layer signaling.

In one embodiment, the response to the first signal is transmitted on a PDCCH.

In one embodiment, the response to the first signal comprises Msg4.

In one embodiment, the response to the first signal comprises MsgB.

In one embodiment, the response for the first signal comprises a Contention Resolution PDSCH.

In one embodiment, a CRC of the response to the first signal is scrambled by a C-RNTI or a Modulation and Coding Scheme (MCS)-C-RNTI.

In one embodiment, a CRC of the response to the first signal is scrambled by a TC-RNTI.

In one embodiment, a CRC of the response to the first signal is scrambled by a C-RNTI.

In one embodiment, a CRC of the response to the first signal is scrambled by a MsgB-RNTI.

In one embodiment, a CRC of the response to the first signal is scrambled by a Random Access (RA)-RNTI.

In one embodiment, the first signal comprises a PUSCH transmission, a HARQ (Hybrid Automatic Repeat reQuest) process number of the PUSCH is a first HARQ process number: the response to the first signal is a PUSCH scheduled DCI indicating the first HARQ process number and a toggled NDI (New Data Indicator) field value.

In one embodiment, for the procedure of beam failure recovery, refer to chapter 5.17 of 3GPP TS38.321.

In one embodiment, for the procedure of beam failure recovery, refer to chapter 6 of 3GPP TS38.213.

In one embodiment, the first RS resource set is used for a radio link quality evaluation of the first BWP; radio link quality evaluation of the first BWP comprises: respectively evaluating radio link quality according to the first RS resource set and a second RS resource set: when the radio link quality evaluated according to all RS resources in the first RS resource set is worse than a first reference threshold, physical layer of the first node transmits a beam failure instance indication for the first RS resource set to its higher layer: when the radio link quality evaluated according to all RS resources in the second RS resource set is worse than the first reference threshold, physical layer of the first node transmits a beam failure instance indication for the second RS resource set to its higher layer.

In one embodiment, a first counter is used for counting beam failure instance indications for the first RS resource set, and a second counter is used for counting beam failure instance indications for the second RS resource set: when a value of a first counter is equal to or greater than a first threshold, a beam failure recovery for the first RS resource set is triggered: when a value of the second counter is equal to or greater than a second threshold, beam failure recovery for the second RS resource set is triggered.

In one embodiment, the reference information block is used to determine the second RS resource set used for radio link quality measurement of the first BWP.

In one embodiment, the second RS resource set comprises at least one SS/PBCH block resource.

In one embodiment, the second RS resource set comprises at one periodic CSI-RS resource.

In one embodiment, the second RS resource set comprises one or two of a periodic CSI-RS resource and an SS/PBCH block.

In one embodiment, the second RS resource set is q̅₀.

In one embodiment, the second RS resource set is q̅_{0,0}.

In one embodiment, the second RS resource set is q̅_{0,1}.

In one embodiment, the reference information block is used to configure a second CORESET pool on a first BWP, and the second CORESET pool comprises at least one CORESET: the second RS resource set depends on at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set is determined according to an RS index of at least one RS resource indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set is determined according to an RS index configured with QCL type ‘typeD’ in at least one RS resource indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set comprises at least one RS resource indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set comprises an RS resource configured with QCL type ‘typeD’ in at least one RS resource indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set is determined according to a periodic CSI-RS resource configuration index with a same value as an RS index of at least one RS resource indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set is determined according to a periodic CSI-RS resource configuration index with a same value as an RS index configured with QCL type ‘typeD’ in at least one RS resource indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set is determined according to a periodic CSI-RS resource configuration index with a same value as an RS index of at least one RS resource indicated by at least one TCI state of at least one CORESET in the second CORESET pool: for a TCI state indicating multiple RS resources in at least one TCI state in at least one CORESET in the second CORESET, the second RS resource set only comprises RS resources configured with QCL type ‘typeD’.

In one embodiment, the meaning of the phrase that “the second RS resource set depends on at least one TCI state of at least one CORESET in the second CORESET pool” comprises: the second RS resource set comprises at least one periodic CSI-RS resource, and an index of the at least one periodic CSI-RS resource is the same as an RS index of at least one RS resource indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set comprises at least one periodic CSI-RS resource, and an index of the at least one periodic CSI-RS resource is the same as an RS index configured with QCL type ‘typeD’ of at least one RS resource indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set comprises at least one periodic CSI-RS resource, and an index of the at least one periodic CSI-RS resource is the same as an RS index of at least one RS resource indicated by at least one TCI state of at least one CORESET in the second CORESET pool: for a TCI state indicating multiple RS resources in at least one TCI state in at least one CORESET in the second CORESET, the second RS resource set only comprises RS resources configured with QCL type ‘typeD’.

In one embodiment, the meaning of the phrase that “the second RS resource set depends on at least one TCI state of at least one CORESET in the second CORESET pool” comprises: the second RS resource set is determined according to an SS/PBCH block index with a same value as an RS index of at least one RS resource indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set is determined according to an SS/PBCH block index with a same value as an RS index configured with QCL type ‘typeD’ in at least one RS indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set is determined according to an SS/PBCH block index with a same value as an RS index of at least one RS resource indicated by at least one TCI state of at least one CORESET in the second CORESET pool: for a TCI state indicating multiple RS resources in at least one TCI state in at least one CORESET in the second CORESET, the second RS resource set only comprises RS resources configured with QCL type ‘typeD’.

In one embodiment, the meaning of the phrase that “the second RS resource set depends on at least one TCI state of at least one CORESET in the second CORESET pool” comprises: the second RS resource set comprises at least one SS/PBCH block, and an index of the at least one SS/PBCH block is the same as an RS index of at least one RS resource indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set comprises at least one SS/PBCH block, and an index of the at least one SS/PBCH block is the same as an RS index configured with QCL type ‘typeD’ of at least one RS resource indicated by at least one TCI state of at least one CORESET in the second CORESET pool.

In one embodiment, the meaning of the phrase that “the second RS resource set depends on at least one TCI state of at least one CORESET in the second CORESET pool” comprises: the second RS resource set comprises at least one SS/PBCH block, and an index of the at least one SS/PBCH block is the same as an RS index of at least one RS resource indicated by at least one TCI state of at least one CORESET in the second CORESET pool: for a TCI state indicating multiple RS resources in at least one TCI state in at least one CORESET in the second CORESET, the second RS resource set only comprises RS resources configured with QCL type ‘typeD’.

In one embodiment, the meaning of the phrase that “an index of the at least one periodic CSI-RS resource is the same as an RS index of at least one RS resource indicated by at least one TCI state of at least one CORESET in the second CORESET pool” comprises: an index of the at least one periodic CSI-RS resource comprises at least one RS index in at least one RS indicated by at least one TCI of at least one CORESET in the second CORESET pool.

In one embodiment, the meaning of the phrase that “an index of the at least one periodic CSI-RS resource is the same as an RS index of at least one RS resource indicated by at least one TCI state of at least one CORESET in the second CORESET pool” comprises: an index of the at least one periodic CSI-RS resource comprises an RS index configured with QCL type ‘typeD’ in at least one RS indicated by at least one TCI state of at least one CORESET in the second CORESET pool.

In one embodiment, the meaning of the phrase that “an index of the at least one periodic CSI-RS resource is the same as an RS index of at least one RS resource indicated by at least one TCI state of at least one CORESET in the second CORESET pool” comprises: an index of at least one periodic CSI-RS resource is the same as an RS index configured with QCL type ‘typeD’ in at least one RS indicated by at least one TCI state of at least one CORESET in the second CORESET pool.

In one embodiment, the meaning of the phrase that “an index of the at least one periodic CSI-RS resource is the same as an RS index of at least one RS resource indicated by at least one TCI state of at least one CORESET in the second CORESET pool” comprises: an index of any periodic CSI-RS resource in the at least one periodic CSI-RS resource is the same as an RS index indicated by one TCI state in at least one TCI state of at least one CORESET in the second CORESET pool, and an RS index indicated any TCI state in at least one TCI state of at least one CORESET in the second CORESET pool is the same as an index of a periodic CSI-RS resource in the second RS resource set.

In one embodiment, the meaning of the phrase that “an index of the at least one SS/PBCH block is the same as an RS index of at least one RS resource indicated by at least one TCI state of at least one CORESET in the second CORESET pool” comprises: an index of the at least one SS/PBCH block comprises at least one RS index in at least one TCI state indicated by at least one CORESET in the second CORESET pool.

In one embodiment, the meaning of the phrase that “an index of the at least one SS/PBCH block is the same as an RS index of at least one RS resource indicated by at least one TCI state of at least one CORESET in the second CORESET pool” comprises: an index of the at least one SS/PBCH block comprises an RS index configured with QCL type ‘typeD’ in at least one RS indicated by at least one TCI state of at least one CORESET in the second CORESET pool.

In one embodiment, the meaning of the phrase that “an index of the at least one SS/PBCH block is the same as an RS index of at least one RS resource indicated by at least one TCI state of at least one CORESET in the second CORESET pool” comprises: an index of the at least one SS/PBCH block is the same as an RS index configured with QCL type ‘typeD’ in at least one RS indicated by at least one TCI state of at least one CORESET in the second CORESET pool.

In one embodiment, the meaning of the phrase that “an index of the at least one SS/PBCH block is the same as an RS index of at least one RS resource indicated by at least one TCI state of at least one CORESET in the second CORESET pool” comprises: an index of any SS/PBCH block in the at least one SS/PBCH block is the same as an RS index indicated by one TCI state in at least one TCI state of at least one CORESET in the second CORESET pool, and an RS index indicated by any TCI state in at least one TCI state of at least one CORESET in the second CORESET pool is the same as an index of an SS/PBCH block in the second RS resource set.

Typically, the beam failure instance indication for the first RS resource set is transmitted from the physical layer to its higher layer within the first node.

Typically, the beam failure instance indication for the second RS resource set is transmitted from the physical layer to its higher layer within the first node.

Typically, statistics of a beam failure instance indication for the first RS resource set and statistics of a beam failure instance indication for the second RS resource set are performed separately.

Typically, a beam failure detection for the first RS resource set and a beam failure detection for the second RS resource set are performed separately.

Typically, a beam failure recovery of the first RS resource set and a beam failure recovery of the second RS resource set are triggered separately.

Typically, the first RS resource set and the second RS resource set are two beam failure detection RS sets, and a beam failure detection is performed per beam failure detection RS set.

Typically, the first RS resource set and the second RS resource set are two beam failure detection RS sets, and a beam failure recovery is performed per beam failure detection RS set.

In one embodiment, a first counter is used for counting beam failure instance indications for the first RS resource set, and a second counter is used for counting beam failure instance indications for the second RS resource set: when a value of a first counter is equal to or greater than a first threshold, a beam failure recovery for the first RS resource set is triggered: when a value of the second counter is equal to or greater than a second threshold, a beam failure recovery for the second RS resource set is triggered.

Typically, the first RS resource set and the second RS resource set correspond to two BFI_COUNTERs, respectively:

Typically, the first RS resource set corresponds to a first counter, and the second RS resource set corresponds to a second counter.

Typically, the meaning of the phrase that “when a value of the first counter is equal to or greater than a first threshold” refers to: when and only when a value of a first counter is equal to or greater than a first threshold.

Typically, the meaning of the phrase that “when a value of the first counter is equal to or greater than a first threshold” refers to: as a response to a value of a first counter being equal to or greater than a first threshold.

Typically, the meaning of the phrase that “when a value of the second counter is equal to or greater than a second threshold” refers to: when and only when a value of a second counter is equal to or greater than a second threshold.

Typically, the meaning of the phrase that “when a value of the second counter is equal to or greater than a second threshold” refers to: as a response to a value of a second counter being equal to or greater than a second threshold.

Typically, the first node maintains the first counter at the MAC layer, and the first node maintains the second counter at the MAC layer.

Typically, a MAC entity of the first node maintains the first counter, and a MAC entity of the first node maintains the second counter.

Typically, when a MAC entity of the first node receives a beam failure instance indication for the first RS resource set from physical layer, it starts or restarts a first timer, and a value of the first counter is incremented by 1: whenever a MAC entity of the first node receives a beam failure instance indication for the second RS resource set from physical layer, it starts or restarts a second timer, and a value of the second counter is incremented by 1.

Typically, the first counter and the second counter are two BFI_COUNTERs.

Typically, when the first timer expires, set the first counter to 0; when the second timer expires, set the second counter to 0.

In one embodiment, the first timer and the second timer are two beamFailureDetection Timers.

Typically, an initial value of the first counter is 0, and an initial value of the second counter is 0.

In one embodiment, the first threshold is a positive integer, and the second threshold is a positive integer.

In one embodiment, the first threshold and the first threshold are configured beam FailureInstanceMaxCount-r17, respectively.

In one embodiment, a name of the first threshold comprises beamFailureInstanceMaxCount, and a name of the second threshold comprises beam FailureInstanceMaxCount.

In one embodiment, the first threshold and the second threshold are respectively configured by RRC parameters.

In one embodiment, the first threshold and the second threshold are the same.

In one embodiment, the first threshold and the second threshold are different.

In one embodiment, the first threshold and the second threshold are configured by partial or all fields in an RRC IE.

In one embodiment, an RRC message configuring the first threshold and the second threshold comprises two beamFailureInstanceMaxCount-r17 fields of a RadioLinkMonitoringConfig IE.

In one embodiment, an RRC message configuring the first threshold and the second threshold comprises partial or all information in two failureDetectionSet1-r17 fields of a RadioLinkMonitoringConfig IE, respectively.

In one embodiment, RRC messages configuring the first threshold and the second threshold respectively comprise partial or all information in a field whose name comprises failureDetectionSet1 in a RadioLinkMonitoringConfig IE, and RRC messages configuring the first threshold and the second threshold respectively comprise partial or all information in a field whose name comprises failureDetectionSet2 in a RadioLinkMonitoringConfig IE.

In one embodiment, an initial value of the first timer is the same as an initial value of the second timer.

In one embodiment, an initial value of the first timer is different from an initial value of the second timer.

In one embodiment, an initial value of the first timer and an initial value of the second timer are configured by RRC parameters, respectively.

In one embodiment, the first timer and the second timer are two beam FailureDetection Timer-r17, respectively:

In one embodiment, names of the first timer and the second timer both comprise beam FailureDetection Timer-r17.

In one embodiment, an initial value of the first timer is a positive integer, and an initial value of the second timer is a positive integer.

In one embodiment, an initial value of the first timer is a positive real number, and an initial value of the second timer is a positive real number.

In one embodiment, a unit of an initial value of the first timer and a unit of an initial value of the second timer are both Qout,LR reporting periods of beam failure detection RS.

In one embodiment, an initial value of the first timer and an initial value of the first timer are configured by two higher-layer parameters beamFailureDetectionTimer-r17, respectively.

In one embodiment, an initial value of the first timer and an initial value of the second timer are configured by two higher-layer parameters whose name comprise beamFailureDetectionTimer-r17, respectively.

In one embodiment, an initial value of the first timer and an initial value of the second timer are configured by an IE.

In one embodiment, a name of an IE configuring an initial value of the first timer and an initial value of the second timer comprises RadioLinkMonitoring.

Typically, when beam failure recovery for the first RS resource set and beam failure recovery for the second RS resource set are both triggered, and beam failure recovery procedure for either the first RS resource set or the second RS resource set is not successfully completed, initiate a random access procedure.

In one embodiment, the BFR for the first RS resource set comprises transmitting one of a BFR MAC CE, a Truncated BFR MAC CE, an Enhanced BFR MAC CE, or a Truncated Enhanced BFR MAC CE: the BFR for the second RS resource set comprises transmitting one of a BFR MAC CE, a Truncated BFR MAC CE, an Enhanced BFR MAC CE, or a Truncated Enhanced BFR MAC CE.

In one embodiment, the BFR for the first RS resource set comprises transmitting a MAC CE whose name comprises BFR, and the BFR for the second RS resource set comprises transmitting a MAC CE whose name comprises BFR.

In one embodiment, when beam failure recovery for only the first RS resource set in the first RS resource set or the second RS resource set is triggered, the BFR for the first RS resource set comprises transmitting a first PUSCH, and a name of the first PUSCH bearer comprises a MAC CE of BFR: if the first transceiver receives a response for the first PUSCH, the beam failure recovery for the first RS resource set is successfully completed.

In one embodiment, if the first transceiver does not receive a response for the first PUSCH, the beam failure recovery for the first RS resource set is not successfully completed.

In one embodiment, the response to the first PUSCH comprises Downlink control information (DCI).

In one embodiment, the response to the first PUSCH comprises a physical-layer signaling.

In one embodiment, the response to the first PUSCH is transmitted on a PDCCH.

In one embodiment, the response to the first PUSCH is a PUSCH scheduled DCI indicating “a same process number as a process number of the first PUSCH” and “a toggled NDI field value”.

In one embodiment, when beam failure recovery for only the second RS resource set in the first RS resource set or the second RS resource set is triggered, the BFR for the second RS resource set comprises transmitting a second PUSCH, and a name of the second PUSCH bearer comprises a MAC CE of BFR: if the first transceiver receives a response for the second PUSCH, the beam failure recovery for the second RS resource set is successfully completed.

In one embodiment, if the first transceiver does not receive a response for the second PUSCH, the beam failure recovery for the second RS resource set is not successfully completed.

In one embodiment, the response for the second PUSCH comprises Downlink control information (DCI).

In one embodiment, the response to the second PUSCH comprises a physical-layer signaling.

In one embodiment, the response to the second PUSCH is transmitted on a PDCCH.

In one embodiment, the response to the second PUSCH is a PUSCH scheduled DCI indicating “a same process number as a process number of the second PUSCH” and “a toggled NDI field value”.

### Embodiment 11

Embodiment 11 illustrates a schematic diagram of relations among a first RS resource, radio link quality and a second reference threshold according to one embodiment of the present application, as shown in FIG. 11.

In embodiment 11, the first RS resource set is used for candidate beam monitoring: in an evaluation period, the first node evaluates whether radio link quality measured based on at least one transmission occasion of the first RS resource is greater than a second reference threshold, or whether radio link quality measured based on at least one transmission occasion of the first RS resource is equal to or greater than a second reference threshold.

In one embodiment, the first node evaluates whether radio link quality measured based on at least one transmission occasion of the first RS resource is greater than a second reference threshold.

In one embodiment, the first node evaluates whether radio link quality measured based on at least one transmission occasion of the first RS resource is equal to or greater than a second reference threshold.

In one embodiment, a measurement on the first RS resource in an evaluation period is used for a radio link quality evaluation, and the result of the radio link quality evaluation refers to whether the radio link quality is greater than a second reference threshold: the result of the radio link quality evaluation refers to whether a new candidate beam is found.

In one embodiment, a measurement on the first RS resource in an evaluation period is used for a radio link quality evaluation, and the result of the radio link quality evaluation refers to whether the radio link quality is equal to or greater than a second reference threshold: the result of the radio link quality evaluation refers to whether a new candidate beam is found.

In one embodiment, the radio link quality is L1-RSRP (Layer1 Reference Signal Received Power).

In one embodiment, the radio link quality is L1-RSRP: when the radio link quality is greater than the second reference threshold, the radio link quality is greater than the second reference threshold: when the radio link quality is less than the second reference threshold, the radio link quality is worse than the second reference threshold.

In one embodiment, the second reference threshold is Q_{in_LR}.

In one embodiment, the first RS resource is an SS/PBCH block resource, and the radio link quality is L1-RSRP obtained based on a measurement on the first RS resource.

In one embodiment, the first RS resource is a CSI-RS resource, and the radio link quality is obtained by subtracting a first power value from L1-RSRP measured by the first RS resource, and the first power value is a power offset of the first RS resource to an SS/PBCH block resource: the L1-RSRP, the first power value, power of the first RS resource, and power of an SS/PBCH block resource are all measured by dB.

In one embodiment, the second reference threshold is indicated by a higher-layer parameter rsrp-ThresholdSSB.

In one embodiment, the first power value is configured by a higher-layer parameter powerControlOffsetSS.

In one embodiment, the first RS resource is an SS/PBCH block resource, and the second reference threshold is rsrp-ThresholdSSB.

In one embodiment, the first RS resource is a CSI-RS resource, and the second reference threshold is rsrp-ThresholdCSI-RS.

In one embodiment, the radio link quality is L1-RSRP: when radio link quality evaluated according to one RS resource in the first RS resource set is greater than a second reference threshold, physical layer of the first node transmits a configuration index and measured L1-RSRP of the first RS resource to its higher layer.

In one embodiment, the radio link quality is L1-RSRP; when radio link quality evaluated according to the first RS resource is greater than a second reference threshold, physical layer of the first node transmits a configuration index and measured L1-RSRP of the first RS resource to its higher layer.

In one embodiment, the radio link quality is L1-RSRP: when radio link quality evaluated according to one RS resource in the first RS resource set is equal to or greater than the second reference threshold, physical layer of the first node transmits a configuration index and measured L1-RSRP of the first RS resource to its higher layer.

In one embodiment, the radio link quality is L1-RSRP; when radio link quality evaluated according to the first RS resource is equal to or greater than a second reference threshold, physical layer of the first node transmits a configuration index and measured L1-RSRP of the first RS resource to its higher layer.

### Embodiment 12

Embodiment 12 illustrates a schematic diagram of relations among a first RS resource, radio link quality and a third reference threshold according to one embodiment of the present application, as shown in FIG. 12.

In embodiment 12, the first RS resource set is used for radio link monitoring: in an evaluation period, the first node evaluates whether radio link quality measured based on at least one transmission occasion of the first RS resource is worse than a third reference threshold.

In one embodiment, a measurement on the first RS resource in an evaluation period is used for a radio link quality evaluation, and the result of the radio link quality evaluation refers to whether the radio link quality is worse than a third reference threshold; the result of the radio link quality evaluation refers to whether to transmit an out-of-sync indication to higher layer.

In one embodiment, the third reference threshold is Qₒᵤₜ.

In one embodiment, the first RS resource is an SS/PBCH block resource, and the third reference threshold is Q_{out_SSB}.

In one embodiment, the first RS resource is a CSI-RS resource, and the third reference threshold is Q_{out_CSI-RS}.

In one embodiment, the third reference threshold is configured by a parameter rlmInSyncOutOfSync Threshold.

In one embodiment, when the radio link quality is worse than the third reference threshold, physical layer of the first node indicates out-of-sync to its higher layer.

In one embodiment, when radio link quality evaluated according to all RS resources in the first RS resource set is worse than the third reference threshold, physical layer of the first node indicates out-of-sync to its higher layer.

In one embodiment, the first RS resource set is used for radio link monitoring: the first node evaluates radio link quality once in a most recent evaluation period per indication period: when the radio link quality is worse than a third reference threshold, physical layer of the first node indicates out-of-sync to its higher layer.

In one embodiment, an indication period comprises a period.

In one embodiment, a length of an indication period is not less than 10 milliseconds (msec).

In one embodiment, in non-DRX (Discontinuous Reception) mode, a length of an indication period is a maximum value in a shortest period of RS resources in the first RS resource set and 10 milliseconds.

In one embodiment, in DRX mode, a length of an indication period is a maximum value in a shortest period of RS resources in the first RS resource set and a DRX period.

In one embodiment, the third reference threshold is a level at which a downlink radio level link cannot be reliably received, the third reference threshold corresponds to a third target threshold, and the third target threshold is out-of-sync BLER.

In one subembodiment of the above embodiment, the first RS resource is used for measuring the downlink radio level link.

In one embodiment, the meaning that “the third reference threshold correspond to a third target threshold” includes: the third target threshold is used to calculate the third reference threshold.

In one embodiment, the meaning that “the third reference threshold correspond to a third target threshold” includes: the third reference threshold is calculated by a formula, and the formula comprises the third target threshold.

In one embodiment, the meaning that “the third reference threshold correspond to a third target threshold” includes: a size of the third reference threshold changes with the third target threshold.

In one embodiment, the meaning that “the third reference threshold correspond to a third target threshold” includes: the third target threshold is used to determine a size of the third reference threshold, and the third reference threshold is indeed determined by the third node itself or implementation related.

In one embodiment, the first RS resource is an SSB resource, the third reference threshold is Q_{out_SSB}, and the third reference threshold is obtained based on hypothetical PDCCH transmission parameters.

In one embodiment, the first RS resource is a CSI-RS resource, the third reference threshold is Q_{out-CSI-RS}, and the third reference threshold is obtained based on hypothetical PDCCH transmission parameters.

### Embodiment 13

Embodiment 13 illustrates a schematic diagram of relations among a first RS resource, radio link quality and a fourth reference threshold according to one embodiment of the present application, as shown in FIG. 13.

In embodiment 13, the first RS resource set is used for radio link monitoring: in an evaluation period, the first node evaluates whether radio link quality measured based on at least one transmission occasion of the first RS resource is greater than a fourth reference threshold, or whether radio link quality measured based on at least one transmission occasion of the first RS resource is equal to or greater than a fourth reference threshold.

In one embodiment, in an evaluation period, the first node evaluates whether radio link quality measured based on at least one transmission occasion of the first RS resource is greater than a fourth reference threshold.

In one embodiment, in an evaluation period, the first node evaluates whether radio link quality measured based on at least one transmission occasion of the first RS resource is equal to or greater than a fourth reference threshold.

In one embodiment, a measurement on the first RS resource in an evaluation period is used for a radio link quality evaluation, and the result of the radio link quality evaluation refers to whether the radio link quality is greater than a fourth reference threshold; the result of the radio link quality evaluation refers to whether to transmit an in-sync indication to higher layer.

In one embodiment, a measurement on the first RS resource in an evaluation period is used for a radio link quality evaluation, and the result of the radio link quality evaluation refers to whether the radio link quality is equal to or greater than a fourth reference threshold; the result of the radio link quality evaluation refers to whether to transmit an in-sync indication to higher layer.

In one embodiment, the fourth reference threshold is Qᵢₙ.

In one embodiment, the first RS resource is an SS/PBCH block resource, and the fourth reference threshold is Q_{in_SSB}.

In one embodiment, the first RS resource is a CSI-RS resource, and the fourth reference threshold is Q_{in-CSI-RS}.

In one embodiment, the fourth reference threshold is configured by a parameter rlmInSyncOutOfSync Threshold.

In one embodiment, when the radio link quality is greater than a fourth reference threshold, physical layer of the first node indicates in-sync to its higher layer.

In one embodiment, when the radio link quality evaluated according to one RS resource in the first RS resource set is greater than the fourth reference threshold, physical layer of the first node indicates in-sync to its higher layer.

In one embodiment, when the radio link quality evaluated according to the first RS resource is greater than the fourth reference threshold, physical layer of the first node indicates in-sync to its higher layer.

In one embodiment, when the radio link quality is equal to or greater than a fourth reference threshold, physical layer of the first node indicates in-sync to its higher layer.

In one embodiment, when radio link quality evaluated according to one RS resource in the first RS resource set is equal to or greater than the fourth reference threshold, physical layer of the first node indicates in-sync to its higher layer.

In one embodiment, when radio link quality evaluated according to the first RS resource is equal to or greater than the fourth reference threshold, physical layer of the first node indicates in-sync to its higher layer.

In one embodiment, the first RS resource set is used for radio link monitoring: the first node evaluates radio link quality once in a most recent evaluation period per indication period: when the radio link quality is equal to or greater than a fourth reference threshold, physical layer of the first node indicates in-sync to its higher layer.

In one embodiment, the first RS resource set is used for radio link monitoring: the first node evaluates radio link quality once in a most recent evaluation period per indication period: when the radio link quality is greater than a fourth reference threshold, physical layer of the first node indicates in-sync to its higher layer.

In one embodiment, an indication period comprises a time period.

In one embodiment, a length of an indication period is not less than 10 milliseconds (msec).

In one embodiment, in non-DRX (Discontinuous Reception) mode, a length of an indication period is a maximum value in a shortest period of RS resources in the first RS resource set and 10 milliseconds.

In one embodiment, in DRX mode, a length of an indication period is a maximum value in a shortest period of RS resources in the first RS resource set and a DRX period.

In one embodiment, the fourth reference threshold is a level at which downlink radio link quality can be received with significantly higher reliability compared to downlink radio link quality Qₒᵤₜ, the fourth reference threshold corresponds to a fourth target threshold, and the fourth target threshold is in-sync BLER.

In one subembodiment of the above embodiment, the first RS resource is used for a measurement of the downlink radio link quality:

In one embodiment, the meaning that “the fourth reference threshold correspond to a fourth target threshold” includes: the fourth target threshold is used to calculate the fourth reference threshold.

In one embodiment, the meaning that “the fourth reference threshold correspond to a fourth target threshold” includes: the fourth reference threshold is calculated by a formula, and the formula comprises the fourth target threshold.

In one embodiment, the meaning that “the fourth reference threshold correspond to a fourth target threshold” includes: a size of the fourth reference threshold changes with the fourth target threshold.

In one embodiment, the meaning that “the fourth reference threshold correspond to a fourth target threshold” includes: the fourth target threshold is used to determine a size of the fourth reference threshold, and the fourth reference threshold is indeed determined by the fourth node itself or implementation related.

In one embodiment, the first RS resource is an SSB resource, the fourth reference threshold is Q_{in_SSB}, and the fourth reference threshold is obtained based on hypothetical PDCCH transmission parameters.

In one embodiment, the first RS resource is a CSI-RS resource, the fourth reference threshold is Q_{in_CSI-RS}, and the fourth reference threshold is obtained based on hypothetical PDCCH transmission parameters.

### Embodiments 14A-14B

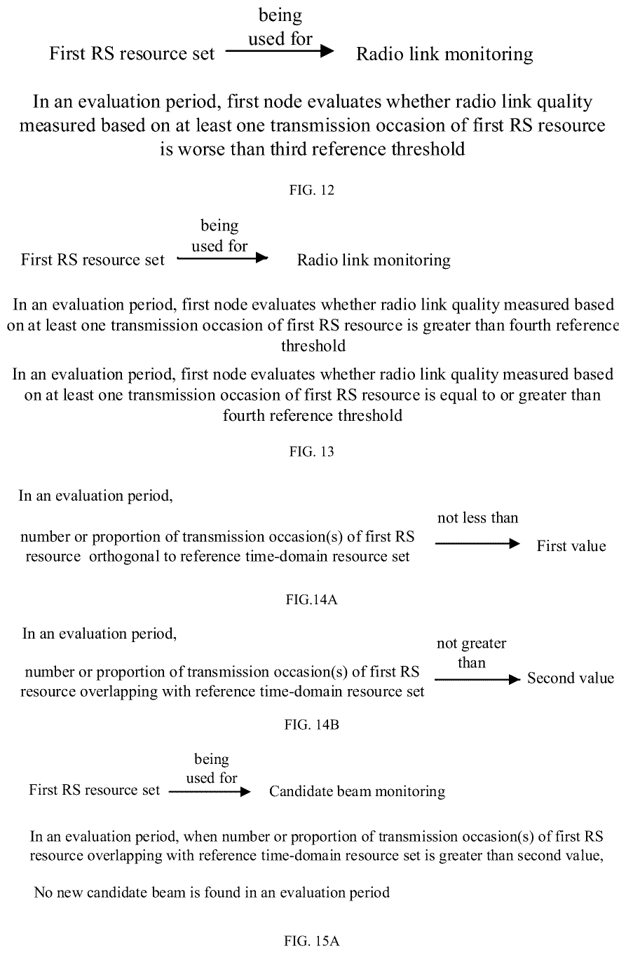

Embodiments 14A-14B respectively illustrate a schematic diagram of a first value and a second value according to one embodiment of the present application, as shown in FIGS. 14A-14B.

In embodiment 14A, in an evaluation period, a number or proportion of transmission occasion(s) of the first RS resource orthogonal to the reference time-domain resource set is not less than a first value.

In embodiment 14B, in an evaluation period, a number or proportion of transmission occasion(s) of the first RS resource overlapping with the reference time-domain resource set is not greater than a second value.

In one embodiment, the first value is a positive integer.

In one embodiment, the first value is 3.

In one embodiment, the first value is 5.

In one embodiment, the first value is 7.

In one embodiment, the first value is L_{CBD.max}.

In one embodiment, the first value is L_{in.max}.

In one embodiment, the first value is a positive real number.

In one embodiment, the first value is greater than 0 and less than 1.

In one embodiment, the first value is 1.

In one embodiment, the second value is a positive integer.

In one embodiment, the second value is 3.

In one embodiment, the second value is 5.

In one embodiment, the second value is 7.

In one embodiment, the second value is L_{CBD.max}.

In one embodiment, the second value is L_{in.max}.

In one embodiment, the second value is a positive real number.

In one embodiment, the second value is greater than 0 and less than 1.

In one embodiment, the second value is 0.

In one embodiment, the first value is the same as the second value.

In one embodiment, the first value is different from the second value.

In one embodiment, a measurement on the first RS resource in an evaluation period is used for a radio link quality evaluation, and a result of the radio link quality evaluation depends on a number of transmission occasion(s) of the first RS resource orthogonal to the reference time-domain resources in the evaluation period.

In one embodiment, a measurement on the first RS resource in an evaluation period is used for a radio link quality evaluation, and a result of the radio link quality evaluation depends on a number of transmission occasion(s) of the first RS resource overlapping with the reference time-domain resources in the evaluation period.

Advantage of the above method is that it ensures a sufficient number of measurements in an evaluation period.

In one embodiment, in an evaluation period, a number of transmission occasion(s) of the first RS resource orthogonal to the reference time-domain resource set is equal to a first value.

In one embodiment, in an evaluation period, a number of transmission occasion(s) of the first RS resource orthogonal to the reference time-domain resource set is not less than a first value.

In one embodiment, a proportion of a transmission occasion of the first RS resource orthogonal to the reference time-domain resource set in an evaluation period refers to: a ratio of transmission occasion(s) of the first RS resource orthogonal to the reference time domain resource set in an evaluation period to a total number of transmission occasion(s) of the first RS resource in the evaluation period.

In one embodiment, in an evaluation period, a number of transmission occasion(s) of the first RS resource overlapping with the reference time-domain resource set is equal to a second value.

In one embodiment, in an evaluation period, a number of transmission occasion(s) of the first RS resource overlapping with the reference time-domain resource set is not greater than a second value.

In one embodiment, the first RS resource set is used for beam failure monitoring: in an evaluation period, when a number or proportion of transmission occasion(s) of the first RS resource orthogonal to the reference time-domain resource set is lower than a first value, no beam failure instance is found in the evaluation period.

In one embodiment, the first RS resource set is used for beam failure monitoring: in an evaluation period, when a number or proportion of transmission occasion(s) of the first RS resource orthogonal to the reference time-domain resource set is less than a first value, the first node drops evaluating radio link quality on the first RS resource in the evaluation period.

In one embodiment, the first RS resource set is used for beam failure monitoring: in an evaluation period, when a number or proportion of transmission occasion(s) of the first RS resource orthogonal to the reference time-domain resource set is less than a first value, radio link quality evaluated on the first RS resource in the evaluation period is not worse than a reference threshold.

In one subembodiment of the above embodiment, “radio link quality evaluated on the first RS resource in the evaluation period being not worse than a reference threshold” comprises: the first node assumes that radio link quality evaluated on the first RS resource in the evaluation period is not worse than a reference threshold.

In one embodiment, the first RS resource set is used for beam failure monitoring: in an evaluation period, when a number or proportion of transmission occasion(s) of the first RS resource overlapping with the reference time-domain resource set is greater than a second value, no beam failure instance is found in the evaluation period.

In one embodiment, the first RS resource set is used for beam failure monitoring: in an evaluation period, when a number or proportion of transmission occasion(s) of the first RS resource overlapping with the reference time-domain resource set is greater than a second value, the first node drops evaluating radio link quality on the first RS resource in the evaluation period.

In one embodiment, the first RS resource set is used for beam failure monitoring: in an evaluation period, when a number or proportion of transmission occasion(s) of the first RS resource overlapping with the reference time-domain resource set is greater than a second value, radio link quality evaluated on the first RS resource in the evaluation period is not worse than a reference threshold.

In one embodiment, “radio link quality evaluated on the first RS resource in the evaluation period being not worse than a reference threshold” comprises: the first node assumes that radio link quality evaluated on the first RS resource in the evaluation period is not worse than a reference threshold.

In one embodiment, the first RS resource set is used for candidate beam monitoring, and in an evaluation period, when a number or proportion of transmission occasion(s) of the first RS resource orthogonal to the reference time-domain resource set is less than a first value, no new candidate beam is found in the evaluation period.

In one embodiment, the first RS resource set is used for radio link monitoring, and in an evaluation period, when a number or proportion of transmission occasion(s) of the first RS resource orthogonal to the reference time-domain resource set is less than a first value, the first node does not transmit an in-sync indication to its higher layer.

In one embodiment, the first RS resource set is used for radio link monitoring, and in an evaluation period, when a number or proportion of transmission occasion(s) of the first RS resource orthogonal to the reference time-domain resource set is less than a first value, the first node does not transmit an out-of-sync indication to its higher layer.

In one embodiment, the first RS resource set is used for radio link monitoring, and in an evaluation period, when a number or proportion of transmission occasion(s) of the first RS resource overlapping with the reference time-domain resource set is greater than a second value, the first node does not transmit an out-of-sync indication to its higher layer.

### Embodiments 15A-15B

Embodiments 15A-15B respectively illustrate a schematic diagram of a number or proportion of transmission occasion(s) of a first RS resource according to one embodiment of the present application, as shown in FIG. 15A-15B.

In embodiment 15A, the first RS resource set is used for candidate beam monitoring, and in an evaluation period, when a number or proportion of transmission occasion(s) of the first RS resource overlapping with the reference time-domain resource set is greater than a second value, no new candidate beam is found in the evaluation period.

In one embodiment, the evaluation period is T_{Evaluate_CBD_SSB}.

In one embodiment, the evaluation period is T_{Evaluate_CBD_CSI-RS}.

In one embodiment, the evaluation period is T_{Evaluate_CBD_SSB} or T_{Evaluate_CBD_CSI-RS}.

In one embodiment, the first RS resource is an SS/PBCH block resource, and the evaluation period is T_{Evaluate_CBD_SSB}.

In one embodiment, the first RS resource is a CSI-RS resource, and the evaluation period is T_{Evaluate_CBD_CSI-RS}.

In one embodiment, the first RS resource set is used for candidate beam monitoring, and the evaluation period is T_{Evaluate-CBD-SSB} Or T_{Evaluate-CBD-CSI-RS}.

In one embodiment, “in the evaluation period, no new candidate beam being found” comprises: the first node assumes that no new candidate beam is found in the evaluation period.

In one embodiment, “in the evaluation period, no new candidate beam being found” comprises: no new candidate beam is found from the first RS resource set in the evaluation period.

In one embodiment, “in the evaluation period, no new candidate beam being found” comprises: in the evaluation period, the first RS resource is not a new candidate beam.

In one embodiment, “in an evaluation period, the first RS resource is not a new candidate beam” comprises: the first node assumes that in the evaluation period, the first RS resource is not a new candidate beam.

In one embodiment, in an evaluation period, when a number of transmission occasion(s) of the first RS resource overlapping with the reference time-domain resource set is greater than a second value, no new candidate beam is found in the evaluation period.

In one embodiment, in an evaluation period, when a number of transmission occasion(s) of the first RS resource overlapping with the reference time-domain resource set is greater than a second value, no new candidate beam is found in the evaluation period.

In one embodiment, in an evaluation period, when a proportion of transmission occasion(s) of the first RS resource overlapping with the reference time-domain resource set is greater than a second value, no new candidate beam is found in the evaluation period.

In embodiment 15B, the first RS resource set is used for radio link monitoring, and in an evaluation period, when a number or proportion of transmission occasion(s) of the first RS resource overlapping with the reference time-domain resource set is greater than a second value, the first node does not transmit an in-sync indication to its higher layer.

In one embodiment, the evaluation period is T_{Evaluate_in_SSB}.

In one embodiment, the evaluation period is T_{Evaluate_in_CSI-RS}.

In one embodiment, the evaluation period is T_{Evaluate_in_SSB} or T_{Evaluate_in_CSI-RS}.

In one embodiment, the first RS resource is an SS/PBCH block resource, and the evaluation period is T_{Evaluate_in_SSB}.

In one embodiment, the first RS resource is a CSI-RS resource, and the evaluation period is T_{Evaluate_in_CSI-RS}.

In one embodiment, the first RS resource set is used for radio link monitoring, and the evaluation period is T_{Evaluate_in_SSB} Or T_{Evaluate_in_CSI-RS}.

In one embodiment, in an evaluation period, when a number of transmission occasion(s) of the first RS resource overlapping with the reference time-domain resource set is greater than a second value, the first node does not transmit an in-sync indication to its higher layer.

In one embodiment, in an evaluation period, when a number of transmission occasion(s) of the first RS resource overlapping with the reference time-domain resource set is greater than a second value, the first node does not transmit an in-sync indication to its higher layer.

In one embodiment, in an evaluation period, when a proportion of transmission occasion(s) of the first RS resource overlapping with the reference time-domain resource set is higher than a second value, the first node does not transmit an in-sync indication to its higher layer.

### Embodiments 16A-16B

Embodiments 16A-16B respectively illustrate a schematic diagram of a length of an evaluation period according to one embodiment of the present application, as shown in FIG. 16A-16B.

In embodiment 16A, a length of an evaluation period depends on a number or proportion of transmission occasion(s) of the first RS resource overlapping with the reference time-domain resource set in the evaluation period.

In one embodiment, a length of an evaluation period depends on a number of transmission occasion(s) of the first RS resource overlapping with the reference time-domain resource set in the evaluation period.

In one embodiment, a length of an evaluation period depends on a proportion of transmission occasion(s) of the first RS resource overlapping with the reference time-domain resource set in the evaluation period.

In one embodiment, in an evaluation period, the larger a number of transmission occasion(s) of the first RS resource overlapping with the reference time-domain resource set, the longer a length of the evaluation period.

In one embodiment, in an evaluation period, the larger a proportion of transmission occasion(s) of the first RS resource overlapping with the reference time-domain resource set, the longer a length of the evaluation period.

In one embodiment, in an evaluation period, the larger a number or proportion of transmission occasion(s) of the first RS resource overlapping with the reference time-domain resource set, the longer a length of the evaluation period.

In embodiment 16B, a length of an evaluation period depends on a number or proportion of transmission occasion(s) of the first RS resource overlapping with the reference time-domain resource set in a most recent evaluation period prior to the evaluation period.

In one embodiment, a length of an evaluation period depends on a number of transmission occasion(s) of the first RS resource overlapping with the reference time-domain resource set in a most recent evaluation period prior to the evaluation period.

In one embodiment, a length of an evaluation period depends on a proportion of transmission occasion(s) of the first RS resource overlapping with the reference time-domain resource set in a most recent evaluation period prior to the evaluation period.

In one embodiment, in a most recent evaluation period prior to an evaluation period, the larger a number of transmission occasion(s) of the first RS resource overlapping with the reference time-domain resource set, the longer a length of the evaluation period.

In one embodiment, in a most recent evaluation period prior to an evaluation period, the larger a proportion of transmission occasion(s) of the first RS resource overlapping with the reference time-domain resource set, the longer a length of the evaluation period.

In one embodiment, in a most recent evaluation period prior to an evaluation period, the larger a number or proportion of transmission occasion(s) of the first RS resource overlapping with the reference time-domain resource set, the longer a length of the evaluation period.

In one embodiment, a length of an evaluation period depends on a number or proportion of transmission occasion(s) of the first RS resource overlapping with the reference time-domain resource set in at least one evaluation period prior to the evaluation period.

### Embodiment 17

Embodiment 17 illustrates a structure block diagram of a processor in a first node according to one embodiment of the present application, as shown in FIG. 17. In FIG. 17, a processor 1700 in a first node comprises a first receiver 1701.

In one embodiment, the first node is a UE.

In one embodiment, the first node is a relay node.

In one embodiment, the first receiver 1701 comprises at least one of the antenna 452, the receiver 454, the receiving processor 456, the multi-antenna receiving processor 458, the controller/processor 459, the memory 460, or the data source 467 in Embodiment 4.

The first receiver 1701 receives a reference information block and a first information block:

In embodiment 17, the reference information block is used to determine a first RS resource set used for a radio link quality measurement, and the first RS resource set comprises at least one RS resource: the first information block is used to determine a reference time-domain resource set: a first RS resource is an RS resource in the first RS resource set, and a transmission occasion of the first RS resource used for the radio link quality measurement depends on the reference time-domain resource set.

In one embodiment, any transmission occasion of the first RS resource used for the radio link quality measurement is orthogonal to the reference time-domain resource set.

In one embodiment, only when the first RS resource is a CSI-RS resource, a transmission occasion of the first RS resource used for the radio link quality measurement depends on the reference time-domain resource set.

In one embodiment, in an evaluation period, the first node evaluates radio link quality based on a measurement on at least one transmission occasion of the first RS resource: in an evaluation period, which transmission occasion(s) of the first RS resource is (are) measured for evaluating the radio link quality depends on the reference time-domain resource set.

In one embodiment, in an evaluation period, a number or proportion of transmission occasion(s) of the first RS resource orthogonal to the reference time-domain resource set is not less than a first value, or a number or proportion of transmission occasion(s) of the first RS resource overlapping with the reference time-domain resource set is not greater than a second value.

In one embodiment, the first RS resource set is used for candidate beam monitoring, and in an evaluation period, when a number or proportion of transmission occasion(s) of the first RS resource overlapping with the reference time-domain resource set is greater than a second value, no new candidate beam is found in the evaluation period:

or, the first RS resource set is used for radio link monitoring, and in an evaluation period, when a number or proportion of transmission occasion(s) of the first RS resource overlapping with the reference time-domain resource set is greater than the second value, the first node does not transmit an in-sync indication to its higher layer.

In one embodiment, a length of an evaluation period depends on a number or proportion of transmission occasion(s) of the first RS resource overlapping with the reference time-domain resource set in the evaluation period: or, a length of an evaluation period depends on a number or proportion of transmission occasion(s) of the first RS resource overlapping with the reference time-domain resource set in a most recent evaluation period prior to the evaluation period.

### Embodiment 18

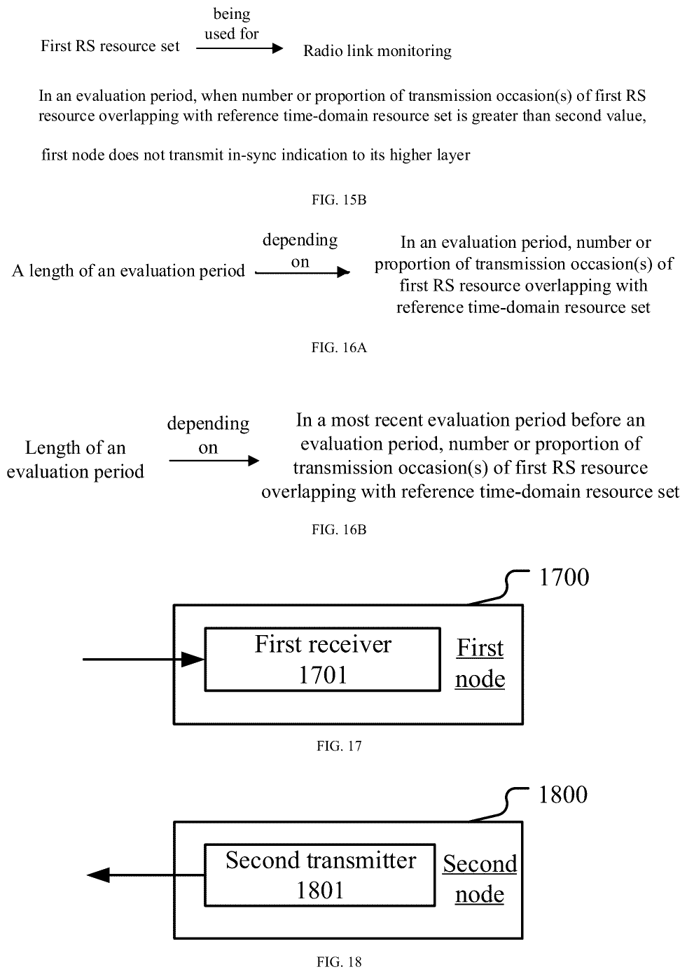

Embodiment 18 illustrates a structure block diagram of a processor in a second node according to one embodiment of the present application, as shown in FIG. 18. In FIG. 18, a processor 1800 in a second node comprises a second transmitter 1801.

In one embodiment, the second node is a base station.

In one embodiment, the second node is a UE.

In one embodiment, the second node is a relay node.

In one embodiment, the second transmitter 1801 comprises at least one of the antenna 420, the transmitter 418, the transmitting processor 416, the multi-antenna transmitting processor 471, the controller/processor 475, or the memory 476 in Embodiment 4.

The second transmitter 1801 transmits a reference information block and a first information block;

In embodiment 18, the reference information block is used to determine a first RS resource set used for a radio link quality measurement, and the first RS resource set comprises at least one RS resource: the first information block is used to determine a reference time-domain resource set: a first RS resource is an RS resource in the first RS resource set, and a transmission occasion of the first RS resource used for the radio link quality measurement depends on the reference time-domain resource set.

In one embodiment, any transmission occasion of the first RS resource used for the radio link quality measurement is orthogonal to the reference time-domain resource set.

In one embodiment, only when the first RS resource is a CSI-RS resource, a transmission occasion of the first RS resource used for the radio link quality measurement depends on the reference time-domain resource set.

In one embodiment, in an evaluation period, a receiver of the first RS resource set evaluates radio link quality based on a measurement on at least one transmission occasion of the first RS resource: in an evaluation period, which transmission occasion(s) of the first RS resource is (are) measured for evaluating the radio link quality depends on the reference time-domain resource set.

In one embodiment, in an evaluation period, a number or proportion of transmission occasion(s) of the first RS resource orthogonal to the reference time-domain resource set is not less than a first value, or a number or proportion of transmission occasion(s) of the first RS resource overlapping with the reference time-domain resource set is not greater than a second value.

In one embodiment, the first RS resource set is used for candidate beam monitoring, and in an evaluation period, when a number or proportion of transmission occasion(s) of the first RS resource overlapping with the reference time-domain resource set is greater than a second value, no new candidate beam is found in the evaluation period:

or, the first RS resource set is used for radio link monitoring, and in an evaluation period, when a number or proportion of transmission occasion(s) of the first RS resource overlapping with the reference time-domain resource set is greater than the second value, a receiver of the first RS resource set does not transmit an in-sync indication to its higher layer.

In one embodiment, a length of an evaluation period depends on a number or proportion of transmission occasion(s) of the first RS resource overlapping with the reference time-domain resource set in the evaluation period: or, a length of an evaluation period depends on a number or proportion of transmission occasion(s) of the first RS resource overlapping with the reference time-domain resource set in a most recent evaluation period prior to the evaluation period.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any changes and modifications made based on the embodiments described in the specification, if similar partial or complete technical effects can be achieved, shall be deemed obvious and fall within the scope of protection of the present invention.

What is claimed is:

1. A first node for wireless communications, comprising:
a first receiver, receiving a reference information block and a first information block;
wherein the reference information block is used to determine a first RS resource set used for a radio link quality measurement, and the first RS resource set comprises at least one RS resource; the first information block is used to determine a reference time-domain resource set; a first RS resource is an RS resource in the first RS resource set, and a transmission occasion of the first RS resource used for the radio link quality measurement depends on the reference time-domain resource set.

2. The first node according to claim 1, wherein
any transmission occasion of the first RS resource used for the radio link quality measurement is orthogonal to the reference time-domain resource set;
or,
any transmission occasion of the first RS resource used for the radio link quality measurement is orthogonal to the reference time-domain resource set: only when the first RS resource is a CSI-RS resource, a transmission occasion of the first RS resource used for the radio link quality measurement depends on the reference time-domain resource set.

3. The first node according to claim 1, wherein in an evaluation period, the first node evaluates radio link quality based on a measurement on at least one transmission occasion of the first RS resource: in an evaluation period, which transmission occasion(s) of the first RS resource is (are) measured for evaluating the radio link quality depends on the reference time-domain resource set.

4. The first node according to claim 3, wherein
in an evaluation period, a number or proportion of transmission occasion(s) of the first RS resource orthogonal to the reference time-domain resource set is not less than a first value, or a number or proportion of transmission occasion(s) of the first RS resource overlapping with the reference time-domain resource set is not greater than a second value;
or,
a length of an evaluation period depends on a number or proportion of transmission occasion(s) of the first RS resource overlapping with the reference time-domain resource set in the evaluation period;
or,
a length of an evaluation period depends on a number or proportion of transmission occasion(s) of the first RS resource overlapping with the reference time-domain resource set in a most recent evaluation period prior to the evaluation period.

5. The first node according to claim 3, wherein
the first RS resource set is used for candidate beam monitoring, and in an evaluation period, when a number or proportion of transmission occasion(s) of the first RS resource overlapping with the reference time-domain resource set is greater than a second value, no new candidate beam is found in the evaluation period;
or,
the first RS resource set is used for radio link monitoring, and in an evaluation period, when a number or proportion of transmission occasion(s) of the first RS resource overlapping with the reference time-domain resource set is greater than the second value, the first node does not transmit an in-sync indication to its higher layer.

6. A second node for wireless communications, comprising:
a second transmitter, transmitting a reference information block and a first information block;
wherein the reference information block is used to determine a first RS resource set used for a radio link quality measurement, and the first RS resource set comprises at least one RS resource; the first information block is used to determine a reference time-domain resource set: a first RS resource is an RS resource in the first RS resource set, and a transmission occasion of the first RS resource used for the radio link quality measurement depends on the reference time-domain resource set.

7. The second node according to claim 6, wherein
any transmission occasion of the first RS resource used for the radio link quality measurement is orthogonal to the reference time-domain resource set;
or,
any transmission occasion of the first RS resource used for the radio link quality measurement is orthogonal to the reference time-domain resource set; only when the first RS resource is a CSI-RS resource, a transmission occasion of the first RS resource used for the radio link quality measurement depends on the reference time-domain resource set.

8. The second node according to claim 6, wherein in an evaluation period, a receiver of the first RS resource set evaluates radio link quality based on a measurement on at least one transmission occasion of the first RS resource; in an evaluation period, which transmission occasion(s) of the first RS resource is (are) measured for evaluating the radio link quality depends on the reference time-domain resource set.

9. The second node according to claim 8, wherein
in an evaluation period, a number or proportion of transmission occasion(s) of the first RS resource orthogonal to the reference time-domain resource set is not less than a first value, or a number or proportion of transmission occasion(s) of the first RS resource overlapping with the reference time-domain resource set is not greater than a second value;
or,
a length of an evaluation period depends on a number or proportion of transmission occasion(s) of the first RS resource overlapping with the reference time-domain resource set in the evaluation period;
or,
a length of an evaluation period depends on a number or proportion of transmission occasion(s) of the first RS resource overlapping with the reference time-domain resource set in a most recent evaluation period prior to the evaluation period.

10. The second node according to claim 8, wherein
the first RS resource set is used for candidate beam monitoring, and in an evaluation period, when a number or proportion of transmission occasion(s) of the first RS resource overlapping with the reference time-domain resource set is greater than a second value, no new candidate beam is found in the evaluation period;
or,
the first RS resource set is used for radio link monitoring, and in an evaluation period, when a number or proportion of transmission occasion(s) of the first RS resource overlapping with the reference time-domain resource set is greater than the second value, a receiver of the first RS resource set does not transmit an in-sync indication to its higher layer.

11. A method in a first node for wireless communications, comprising:
receiving a reference information block and a first information block;
wherein the reference information block is used to determine a first RS resource set used for a radio link quality measurement, and the first RS resource set comprises at least one RS resource; the first information block is used to determine a reference time-domain resource set; a first RS resource is an RS resource in the first RS resource set, and a transmission occasion of the first RS resource used for the radio link quality measurement depends on the reference time-domain resource set.

12. The method according to claim 11, wherein
any transmission occasion of the first RS resource used for the radio link quality measurement is orthogonal to the reference time-domain resource set;
or,
any transmission occasion of the first RS resource used for the radio link quality measurement is orthogonal to the reference time-domain resource set; only when the first RS resource is a CSI-RS resource, a transmission occasion of the first RS resource used for the radio link quality measurement depends on the reference time-domain resource set.

13. The method according to claim 11, wherein in an evaluation period, the first node evaluates radio link quality based on a measurement on at least one transmission occasion of the first RS resource: in an evaluation period, which transmission occasion(s) of the first RS resource is (are) measured for evaluating the radio link quality depends on the reference time-domain resource set.

14. The method according to claim 13, wherein
in an evaluation period, a number or proportion of transmission occasion(s) of the first RS resource orthogonal to the reference time-domain resource set is not less than a first value, or a number or proportion of transmission occasion(s) of the first RS resource overlapping with the reference time-domain resource set is not greater than a second value;
or,
a length of an evaluation period depends on a number or proportion of transmission occasion(s) of the first RS resource overlapping with the reference time-domain resource set in the evaluation period;
or,
a length of an evaluation period depends on a number or proportion of transmission occasion(s) of the first RS resource overlapping with the reference time-domain resource set in a most recent evaluation period prior to the evaluation period.

15. The method according to claim 13, wherein
the first RS resource set is used for candidate beam monitoring, and in an evaluation period, when a number or proportion of transmission occasion(s) of the first RS resource overlapping with the reference time-domain resource set is greater than a second value, no new candidate beam is found in the evaluation period;
or,
the first RS resource set is used for radio link monitoring, and in an evaluation period, when a number or proportion of transmission occasion(s) of the first RS resource overlapping with the reference time-domain resource set is greater than the second value, the first node does not transmit an in-sync indication to its higher layer.

16. A method in a second node for wireless communications, comprising:
transmitting a reference information block and a first information block;
wherein the reference information block is used to determine a first RS resource set used for a radio link quality measurement, and the first RS resource set comprises at least one RS resource; the first information block is used to determine a reference time-domain resource set; a first RS resource is an RS resource in the first RS resource set, and a transmission occasion of the first RS resource used for the radio link quality measurement depends on the reference time-domain resource set.

17. The method according to claim 16, wherein
any transmission occasion of the first RS resource used for the radio link quality measurement is orthogonal to the reference time-domain resource set;
or,
any transmission occasion of the first RS resource used for the radio link quality measurement is orthogonal to the reference time-domain resource set: only when the first RS resource is a CSI-RS resource, a transmission occasion of the first RS resource used for the radio link quality measurement depends on the reference time-domain resource set.

18. The method according to claim 16, wherein in an evaluation period, a receiver of the first RS resource set evaluates radio link quality based on a measurement on at least one transmission occasion of the first RS resource; in an evaluation period, which transmission occasion(s) of the first RS resource is (are) measured for evaluating the radio link quality depends on the reference time-domain resource set.

19. The method according to claim 18, wherein
in an evaluation period, a number or proportion of transmission occasion(s) of the first RS resource orthogonal to the reference time-domain resource set is not less than a first value, or a number or proportion of transmission occasion(s) of the first RS resource overlapping with the reference time-domain resource set is not greater than a second value;
or,
a length of an evaluation period depends on a number or proportion of transmission occasion(s) of the first RS resource overlapping with the reference time-domain resource set in the evaluation period;
or,
a length of an evaluation period depends on a number or proportion of transmission occasion(s) of the first RS resource overlapping with the reference time-domain resource set in a most recent evaluation period prior to the evaluation period.

20. The method according to claim 18, wherein
the first RS resource set is used for candidate beam monitoring, and in an evaluation period, when a number or proportion of transmission occasion(s) of the first RS resource overlapping with the reference time-domain resource set is greater than a second value, no new candidate beam is found in the evaluation period;
or,
the first RS resource set is used for radio link monitoring, and in an evaluation period, when a number or proportion of transmission occasion(s) of the first RS resource overlapping with the reference time-domain resource set is greater than the second value, a receiver of the first RS resource set does not transmit an in-sync indication to its higher layer.
